(19) United States
(12) Patent Application Publication
(10) Pub. No.: US 2025/0292553 A1
(43) Pub. Date: Sep. 18, 2025

(54) DETERMINING ERROR FOR TRAINING COMPUTER-VISION MODELS

(71) Applicant: QUALCOMM Incorporated, San Diego, CA (US)

(72) Inventors: Jisoo JEONG, San Diego, CA (US); Jamie Menjay LIN, San Diego, CA (US); Hong CAI, San Diego, CA (US); Risheek GARREPALLI, San Diego, CA (US); Fatih Murat PORIKLI, San Diego, CA (US)

(21) Appl. No.: 18/771,702

(22) Filed: Jul. 12, 2024

Related U.S. Application Data
(60) Provisional application No. 63/565,337, filed on Mar. 14, 2024.

(51) Int. Cl. G06V 10/776; G06V 10/82

(52) U.S. Cl. CPC G06V 10/776; G06V 10/82

(57) ABSTRACT

Systems and techniques are described herein for processing image data. For instance, a method for processing image data is provided. The method may include predicting, using a machine-learning model, a difference map indicative of differences between a first image and a second image to generate a predicted difference map; determining a confidence map based on the predicted difference map; determining an error based on the confidence map and a comparison of the predicted difference map and a ground-truth difference map; and adjusting one or more parameters of the machine-learning model based on the error.

### CROSS-REFERENCE TO RELATED APPLICATIONS

This application claims the benefit of U.S. Provisional Application No. 63/565,337, filed Mar. 14, 2024, which is incorporated herein by reference in its entirety.

### TECHNICAL FIELD

The present disclosure generally relates to computer vision. For example, aspects of the present disclosure include systems and techniques for determining an error (e.g., a loss) for training machine-learning models for various computer-vision techniques.

### BACKGROUND

In the field of computer vision, the term “optical flow” refers to a representation that describes the pixel-level correspondence between two images and/or techniques used to generate such representations. An optical flow may indicate the difference between the position of an image feature in a first image captured by a camera at a first time and the position of a corresponding image feature in a second image captured by the camera at a second time. Optical flows may include vectors describing movement of image features between images. Optical flow may indicate pixel-level movement in a scene.

In the field of computer vision, the term “disparity map” refers to a representation that describes the pixel-level correspondence between two images and/or techniques used to generate such representations. A disparity map may indicate the difference between the position of an image feature in a first image captured by a first camera and the position of a corresponding image feature in a second image captured by a second camera. The first and second cameras may be a pre-determined distance apart. It is possible to calculate distances between the first and second cameras and various points in a scene based on a disparity map, for example, through three-dimensional triangulation.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, a method is provided for processing image data. The method includes: predicting, using a machine-learning model, an optical flow between a first image and a second image to generate a predicted optical flow, wherein the first image is captured at a first time and wherein the second image is captured at a second time; determining a confidence map based on the predicted optical flow; determining an error based on the confidence map and a comparison of the predicted optical flow and a ground-truth optical flow; and adjusting at least one parameter of the machine-learning model based on the error.

In another example, an apparatus for processing image data is provided that includes at least one memory and one or more processors (e.g., configured in circuitry) coupled to one or more memories. The one or more processors are configured to: predict, using a machine-learning model, an optical flow between a first image and a second image to generate a predicted optical flow, wherein the first image is captured at a first time and wherein the second image is captured at a second time; determine a confidence map based on the predicted optical flow; determine an error based on the confidence map and a comparison of the predicted optical flow and a ground-truth optical flow; and adjust at least one parameter of the machine-learning model based on the error.

In another example, a non-transitory computer-readable medium is provided that has stored thereon instructions that, when executed by one or more processors, cause the one or more processors to: predict, using a machine-learning model, an optical flow between a first image and a second image to generate a predicted optical flow, wherein the first image is captured at a first time and wherein the second image is captured at a second time; determine a confidence map based on the predicted optical flow; determine an error based on the confidence map and a comparison of the predicted optical flow and a ground-truth optical flow; and adjust at least one parameter of the machine-learning model based on the error.

In another example, an apparatus for processing image data is provided. The apparatus includes: means for predicting, using a machine-learning model, an optical flow between a first image and a second image to generate a predicted optical flow, wherein the first image is captured at a first time and wherein the second image is captured at a second time; means for determining a confidence map based on the predicted optical flow; means for determining an error based on the confidence map and a comparison of the predicted optical flow and a ground-truth optical flow; and means for adjusting at least one parameter of the machine-learning model based on the error.

In another example, a method is provided for processing image data. The method includes: predicting, using a machine-learning model, a disparity map between a first image and a second image to generate a predicted disparity map, wherein the first image is captured from a first position and wherein the second image is captured from a second position; determining a confidence map based on the predicted disparity map; determining an error based on the confidence map and a comparison of the predicted disparity map and a ground-truth disparity map; and adjusting at least one parameter of the machine-learning model based on the error.

In another example, an apparatus for processing image data is provided that includes one or more memories and one or more processors (e.g., configured in circuitry) coupled to one or more memories. The one or more processors are configured to: predict, using a machine-learning model, a disparity map between a first image and a second image to generate a predicted disparity map, wherein the first image is captured from a first position and wherein the second image is captured from a second position; determine a confidence map based on the predicted disparity map; determine an error based on the confidence map and a comparison of the predicted disparity map and a ground-truth disparity map; and adjust at least one parameter of the machine-learning model based on the error.

In another example, a non-transitory computer-readable medium is provided that has stored thereon instructions that, when executed by one or more processors, cause the one or more processors to: predict, using a machine-learning model, a disparity map between a first image and a second image to generate a predicted disparity map, wherein the first image is captured from a first position and wherein the second image is captured from a second position; determine a confidence map based on the predicted disparity map; determine an error based on the confidence map and a comparison of the predicted disparity map and a ground-truth disparity map; and adjust at least one parameter of the machine-learning model based on the error.

In another example, an apparatus for processing image data is provided. The apparatus includes: means for predicting, using a machine-learning model, a disparity map between a first image and a second image to generate a predicted disparity map, wherein the first image is captured from a first position and wherein the second image is captured from a second position; means for determining a confidence map based on the predicted disparity map; means for determining an error based on the confidence map and a comparison of the predicted disparity map and a ground-truth disparity map; and means for adjusting at least one parameter of the machine-learning model based on the error.

In another example, a method is provided for processing image data. The method includes: predicting, using a machine-learning model, a difference map indicative of differences between a first image and a second image to generate a predicted difference map; determining a confidence map based on the predicted difference map; determining an error based on the confidence map and a comparison of the predicted difference map and a ground-truth difference map; and adjusting one or more parameters of the machine-learning model based on the error.

In another example, an apparatus for processing image data is provided that includes one or more memories and one or more processors (e.g., configured in circuitry) coupled to the one or more memories. The one or more processors are configured to: predict, using a machine-learning model, a difference map indicative of differences between a first image and a second image to generate a predicted difference map; determine a confidence map based on the predicted difference map; determine an error based on the confidence map and a comparison of the predicted difference map and a ground-truth difference map; and adjust one or more parameters of the machine-learning model based on the error.

In another example, a non-transitory computer-readable medium is provided that has stored thereon instructions that, when executed by one or more processors, cause the one or more processors to: predict, using a machine-learning model, a difference map indicative of differences between a first image and a second image to generate a predicted difference map; determine a confidence map based on the predicted difference map; determine an error based on the confidence map and a comparison of the predicted difference map and a ground-truth difference map; and adjust one or more parameters of the machine-learning model based on the error.

In another example, an apparatus for processing image data is provided. The apparatus includes: means for predicting, using a machine-learning model, a difference map indicative of differences between a first image and a second image to generate a predicted difference map; means for determining a confidence map based on the predicted difference map; means for determining an error based on the confidence map and a comparison of the predicted difference map and a ground-truth difference map; and means for adjusting one or more parameters of the machine-learning model based on the error.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a diagram illustrating an example Regression Focal Loss training pipeline, according to various aspects of the present disclosure;

FIG. 1B is a diagram illustrating an example of a frame of a sequence of frames;

FIG. 1C is a diagram illustrating an example of a frame that is adjacent to the frame of FIG. 1B in the sequence of frames;

FIG. 1D is a diagram illustrating an example of a frame that is adjacent to frame FIG. 1C in the sequence of frames;

FIG. 1E is a diagram illustrating an example Regression Focal Loss training pipeline for disparity estimation, according to various aspects of the present disclosure;

FIG. 1F illustrates two example images, that may be used to determine depth information according to a depth-from-stereo (DFS) depth-estimation technique;

FIG. 1G illustrates two example images and an example associated cost function, according to various aspects of the present disclosure;

FIG. 2 is a block diagram illustrating an example system that may generate an error and may train an optical-flow model based on the error, according to various aspects of the present disclosure;

FIG. 3 is a block diagram illustrating another example system that may generate an error and may train an optical-flow model based on the error, according to various aspects of the present disclosure;

FIG. 4A is a block diagram illustrating another example system that may generate an error and may train an optical-flow model based on the error, according to various aspects of the present disclosure;

FIG. 4B illustrates a forward optical flow between an image Iₜ and an image Iₜ₊₁ and a backward optical flow between an image Iₜ₊₁ and an image Iₜ, according to various aspects of the present disclosure;

FIG. 4C illustrates a process 420 for determining a left-to-right disparity and a right-to-left disparity, according to various aspects of the present disclosure;

FIG. 5 is a block diagram illustrating another example system that may generate an error and may train an optical-flow model based on the error, according to various aspects of the present disclosure;

FIG. 6 is a flow diagram illustrating an example process for determining an error and training an optical-flow model based on the error, in accordance with aspects of the present disclosure;

FIG. 7 is a flow diagram illustrating another example process for determining an error and training an optical-flow model based on the error, in accordance with aspects of the present disclosure;

FIG. 8 illustrates a process is a flow diagram illustrating another example process for determining an error and training an optical-flow model based on the error, in accordance with aspects of the present disclosure;

FIG. 9 is a block diagram illustrating an example of a deep learning neural network that can be used to perform various tasks, according to some aspects of the disclosed technology;

FIG. 10 is a block diagram illustrating an example of a convolutional neural network (CNN), according to various aspects of the present disclosure; and

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, in the field of computer vision, the term “optical flow” refers to a representation that describes the pixel-level correspondence between two images and/or techniques used to generate such representations. An optical flow may indicate the difference between the position of an image feature in a first image captured by a camera at a first time and the position of a corresponding image feature in a second image captured by the camera at a second time. Optical flows may include vectors describing movement of image features between images. Optical flow may indicate pixel-level movement in a scene. Optical flow is a fundamental task that represents pixel-level correspondence between two consecutive frames. Since optical flow provides pixel level movement, it is widely used for multiple video tasks such as action recognition, object tracking, and video compression, among others.

Optical flow can be used in object tracking and/or action-recognition tasks. In addition, optical flow is widely used in video compression and video frame interpolation. Therefore, optical flow can be used in many applications including, as examples, automated driving of a vehicle, assisted driving of a vehicle, extended reality (XR) (including augmented reality (AR), and virtual reality (VR)) and cameras.

Additionally, as mentioned above, in the field of computer vision, the term “disparity map” refers to a representation that describes the pixel-level correspondence between two images and/or techniques used to generate such representations. A disparity map may indicate the difference between the position of an image feature in a first image captured by a first camera and the position of a corresponding image feature in a second image captured by a second camera. The first and second cameras may be a pre-determined distance apart. It is possible to calculate distances between the first and second cameras and various points in a scene based on a disparity map, for example, through three-dimensional triangulation.

Depth information (e.g., a disparity map or a depth map calculated based on a disparity map) may be useful for various tasks such as, three-dimensional (3D) spatial awareness and/or mapping, and/or guidance and navigation (e.g., of a vehicle or robot).

There are a number of challenges in training a machine-learning model to perform optical-flow techniques. There are similar challenges in training a machine-learning model to perform disparity-determination techniques. In the present disclosure, a machine-learning model trained to perform optical-flow techniques may be referred to as an “optical-flow model.” Further, a machine-learning model trained to perform disparity-map techniques may be referred to as an “disparity model.” Additionally, the term “difference map” may refer to either an optical flow or a disparity map. The term “difference model” may refer to either an optical-flow model or a disparity model.

One difficulty of training a model to predict accurate optical flow for pixels of an image is differences between images due to various factors (e.g., feature saliency, lighting conditions, etc.). For instance, it is more difficult to estimate the optical flow for a point that experiences different lighting on two images. This is because in this case it is more difficult to find the correspondence (i.e., pixel matching) across two images. Many approaches to training optical-flow models use equal-weight dense loss across all samples in the dense prediction.

Similarly, in some situations one camera of a stereoscopic pair of cameras may be different than the other (e.g., based on grease on a lens). Such differences may make it more difficult to find the correspondence (i.e., pixel matching) across two images.

Another difficulty of training optical-flow models is training an optical-flow model to handle occlusions. Occlusions due to camera and object motions present one inherent difficulty for model training. In occlusion area, there is no correspondence between pixels of one image and another. Training on occlusion area can skew the network's learning. Many approaches to training optical-flow models use equal-weight dense loss across all samples in the dense prediction.

Similarly, occlusions may affect each camera of a stereoscopic pair of cameras differently. For example, an object close to the pair of camera may block one camera's view of a scene more than the object blocks the other camera's view of the scene. The object may limit correspondence between the two images.

Systems, apparatuses, methods (also referred to as processes), and computer-readable media (collectively referred to herein as “systems and techniques”) are described herein for determining loss for training difference models (e.g., optical-flow models or disparity models). For example, the systems and techniques described herein may leverage estimated confidence maps to guide training losses.

For example, the systems and techniques may determine a confidence map based on the error between ground truth and prediction. The confidence map based on the error between ground truth and prediction captures prediction errors. In the present disclosure, a confidence map based on the error between ground truth and prediction may be referred to as a “learning-difficulty-balancing map” or an “LBD map.” Additionally any error between ground truth and prediction may be referred to as a “learning-difficulty-balancing error,” an “LBD error,” a “learning-difficulty-balancing loss,” or an “LBD loss.”

In the present disclosure, the terms “loss” and “error” both refer to a metric used to determine a difference between a desired outcome and an actual outcome. A loss or an error may be calculated between a result predicted by a machine-learning model and a ground-truth result. In training the machine-learning model, parameters of the machine-learning model may be adjusted based on the loss or error such that in further iterations of the training process, the machine-learning model may predict results that are more similar to ground-truth results. In the present disclosure, the terms “loss” and “error” may be used interchangeably.

Additionally or alternatively, in the case of optical-flow models, the systems and techniques may determine a confidence map based on forward-backward consistency. The forward-backward consistency may be based on a consistency between a forward (in time) optical flow (e.g., an optical flow between a first-captured image and a second-captured image) and a backward (in time) optical flow (e.g., an optical flow between a second-captured image and a first-captured image). The confidence map based on forward-backward consistency may include occlusion information. For example, the confidence map based on forward-backward consistency may capture occlusion areas.

In the case of disparity models, the systems and techniques may determine a confidence map based on a first-second consistency. The first-second consistency may be based on a consistency between a first-to-second disparity map (e.g., a disparity map between an image captured by a first camera and an image captured by a second camera) and a second-to-first disparity map (e.g., a disparity map between an image captured by a second camera and an image captured by a first camera). The confidence map based on first-second consistency may include occlusion information. For example, the confidence map based on first-second consistency may capture occlusion areas.

In the present disclosure, a confidence map based on forward-backward consistency or a first-second consistency may be referred to as an “occlusion-avoiding map” or an “OA map.” Additionally, any error based on forward-backward consistency may be referred to as an “occlusion-avoiding error,” an “OA error,” an “occlusion-avoiding loss,” or an “OA loss.”

The systems and techniques may train difference models (e.g., optical-flow models or disparity models) based on LBD error and/or OA error. In some aspects, the systems and techniques may use LBD error and OA error in an additive fashion, a multiplicative fashion, a mask-based fashion, or a mask-and-additive-based fashion when determining a total error on which to adjust a difference model (e.g., an optical-flow model or a disparity model).

The systems and techniques may train difference models (e.g., optical-flow models or disparity models) that are more accurate than difference models (e.g., optical-flow models or disparity models) trained by other techniques. Additionally or alternatively, training difference models (e.g., optical-flow models or disparity models) by, or according to, the systems and techniques does not impact the latency and/or power consumption of the difference models (e.g., optical-flow models or disparity models) at inference.

Difference models (e.g., optical-flow models or disparity models) models trained by, or according to, the systems and techniques can be used in many applications including, as examples, automated driving of a vehicle, assisted driving of a vehicle, extended reality (XR) (including augmented reality (AR), and virtual reality (VR)) and cameras. Difference models (e.g., optical-flow models or disparity models) trained by, or according to, the systems and techniques can be used in for many tasks, including, as examples, video processing, temporal information aggregation, tracking, etc.

Various aspects of the application will be described with respect to the figures below.

This disclosure introduces a regression focal loss which weights using inverse confidence for each pixel. Existing optical-flow training losses predominantly use equal-weight dense loss across all pixels in the dense prediction, which has been a standard approach for state-of-the-art models of optical flow. However, the difficulty of training a model to predict accurate optical flow for each pixel is different, due to various factors (e.g., feature saliency, lighting conditions, etc.). For instance, it is more difficult to estimate the flow for a point that experiences different lighting in two images. This is because in this case it is more difficult to find the correspondence (i.e., pixel matching) across two images. In this disclosure, more weight is given to the non-confident sample so that training can concentrate on difficult samples in the dataset.

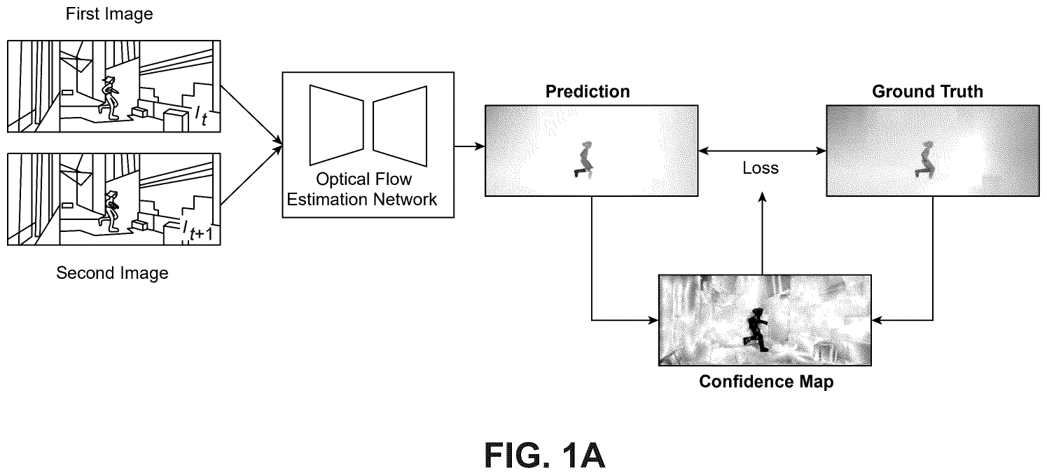

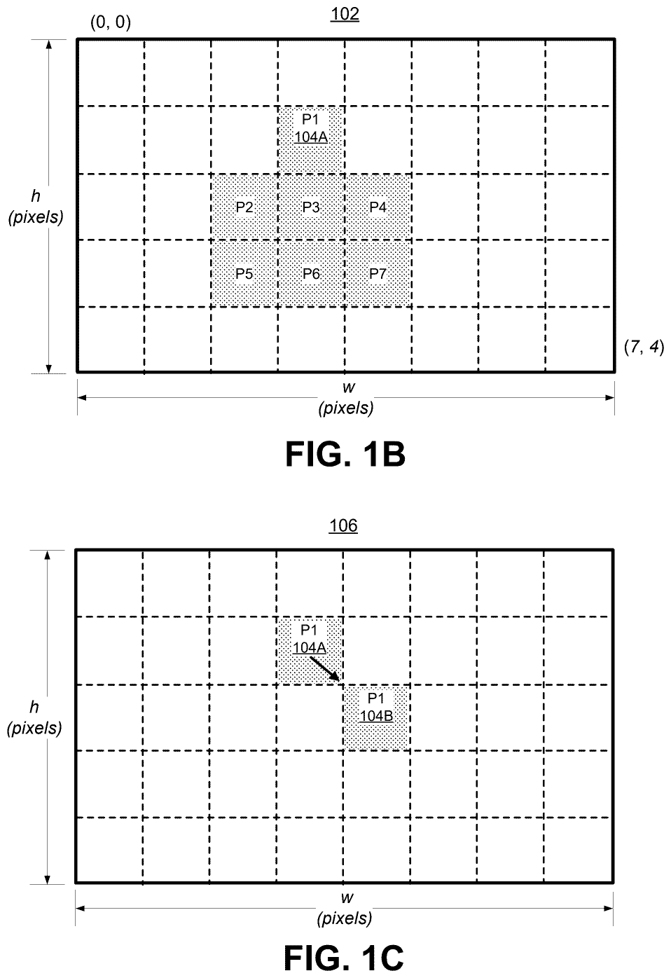

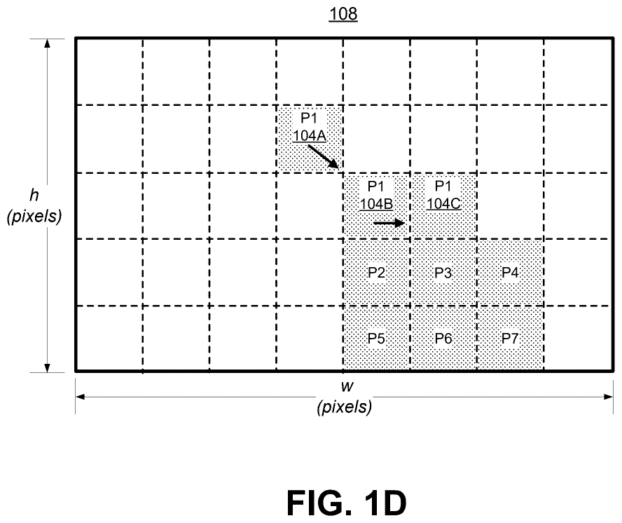

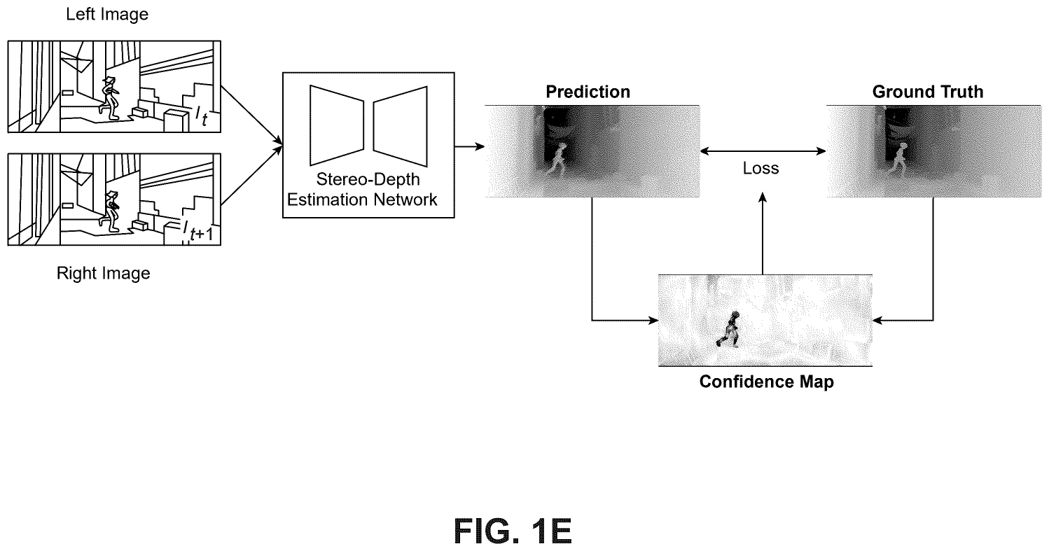

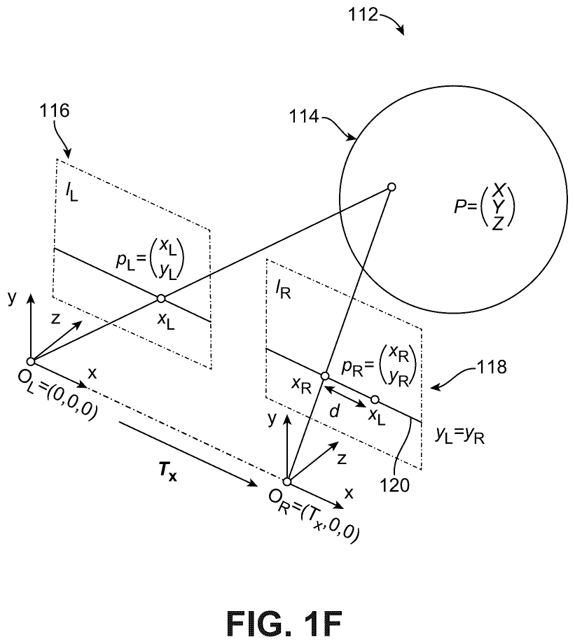

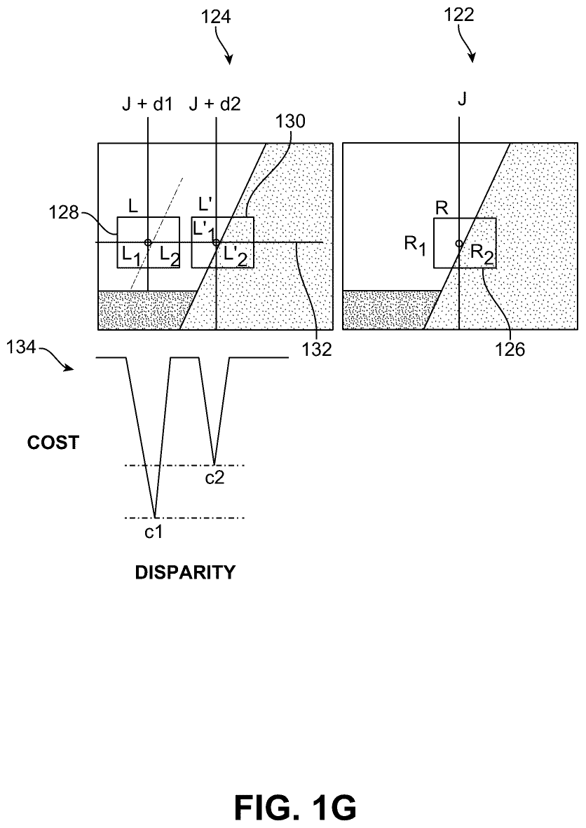

FIG. 1A is a diagram illustrating an example Regression Focal Loss (RFL) training pipeline for optical flow, according to various aspects of the present disclosure. RFL helps models better learn by focusing on pixels of high regression errors. The difficulty of training a model to predict accurate optical flow for each pixel is different. In the FIG. 1A, the human has large displacement, which is hard to find the correspondence and can have large error.

In this disclosure, Regression Focal Loss, which weights using inverse confidence for each pixel, is applied. However, since optical flow provides only regression output, there is a need to find the confidence map for weighting. A confidence map is adopted as follows:

$${M}_{c o n f} ( x ) = {e}^{- {‖ {f}_{g t} ( x ) - {f}_{p r e d} ( x ) ‖}^{2}}$$

This confidence map is as follows:

$${l}_{i} = {‖ ( 1 + α \cdot {( 1 - M )}^{β} ) \cdot ( {f}_{gt} - {f}_{i} ) ‖}_{1}$$

where α and β are the hyperparameters. In the confident area (white area in confidence map in FIG. 1A), it would have original weight (relatively smaller weight). For the non-confident area (black area in confidence map in FIG. 1A), it would have relatively large weight.

The systems and techniques include and/or implement a Regression Focal Loss to encourage the model to better learn on difficult regions, which is beneficial for cases where both training and test data (partially) come from the same domain. The systems and techniques allow optical-flow models to achieve better accuracy when comparing to existing lightweight state-of-the-art optical flow models, while maintaining computation efficiency.

FIG. 1B is a diagram illustrating an example of a frame 102 of a sequence of frames, shown with foreground pixels P1, P2, P3, P4, P5, P6, and P7 (corresponding to an object of interest) at illustrative pixel locations. The other pixels in the frame 102 can be considered background pixels. Frame 102 is shown with dimensions of w pixels wide by h pixels high (denoted as w×h). One of ordinary skill will understand that frame 102 can include many more pixel locations than those illustrated in FIG. 1B. For example, frame 102 can include a 4K (or ultra-high definition (UHD)) frame at a resolution of 3,840×2,160 pixels, an HD frame at a resolution of 1,920×1,080 pixels, or any other suitable frame having another resolution. A pixel P1 is shown at a pixel location 104A. Pixel location 104A can include a (w, h) pixel location of (3, 1) relative to the top-left-most pixel location of (0, 0). The pixel P1 is used for illustrative purposes and can correspond to any suitable point on the object of interest, such as the point of a nose of a person.

FIG. 1C is a diagram illustrating an example of a frame 106 that is adjacent to the frame 102 in the sequence of frames. For instance, frame 106 can occur immediately after frame 102 in the sequence of frames. Frame 106 has the same corresponding pixel locations as that of frame 102 (with dimension w×h). As shown, the pixel P1 has moved from pixel location 104A in frame 102 to an updated pixel location 104B in frame 106. The updated pixel location 104B can include a (w, h) pixel location of (4, 2) relative to the top-left-most pixel location of (0, 0). An optical-flow vector can be computed for the pixel P1, indicating the velocity or optical flow of the pixel P1 from frame 102 to frame 106. In one illustrative example, the optical-flow vector for the pixel P1 between the frame 102 and frame 106 is (1, 1), indicating the pixel P1 has moved one pixel location to the right and one pixel location down.

FIG. 1D is a diagram illustrating an example of a frame 108 that is adjacent to frame 106 in the sequence of frames. For instance, frame 108 can occur immediately after frame 106 in the sequence of frames. Frame 108 has the same corresponding pixel locations as that of frame 102 and frame 106 (with dimensions w×h). As shown, the pixel P1 has moved from pixel location 104B in frame 106 to an updated pixel location 104C in frame 108. The updated pixel location 104C can include a (w, h) pixel location of (5, 2) relative to the top-left-most pixel location of (0, 0). An optical flow vector can be computed for the pixel P1 from frame 106 to frame 108. In one illustrative example, the optical flow vector for the pixel P1 between the frame 106 and frame 108 is (1, 0), indicating the pixel P1 has moved one pixel location to the right. The cumulative optical flow for the pixel P1 from frame 102 to frame 108 can be determined as O_{1,3}=cof(O_{1,2}, O_{2,3}). Using the examples from above, the cumulative optical flow vector O_{1,3} has an (x, y) value equal to (2, 1) based on the sum of the x- and y-directions of the optical flow vectors—cof((1, 1), (1, 0))=(1+1, 1+0). A similar cumulative optical flow can be determined for all other pixels in the frame 102, frame 106, and frame 108.

FIG. 1E is a diagram illustrating an example Regression Focal Loss training pipeline for disparity estimation, according to various aspects of the present disclosure. The difficulty of training a model to predict an accurate disparity map for each pixel is different. In the FIG. 1E, the human has large displacement, which is hard to find the correspondence and can have large error.

In this disclosure, Regression Focal Loss, which weights using inverse confidence for each pixel, is applied. However, since optical flow provides only regression output, there is a need to find the confidence map for weighting. A confidence map is adopted as follows:

$${M}_{c o n f} ( x ) = {e}^{- {‖ {f}_{g t} ( x ) - {f}_{p r e d} ( x ) ‖}^{2}}$$

This confidence map is as follows:

$${l}_{i} = {‖ ( 1 + α \cdot {( 1 - M )}^{β} ) \cdot ( {f}_{gt} - {f}_{i} ) ‖}_{1}$$

where α and β are the hyperparameters. The confident area (e.g., the white area in confidence map in FIG. 1E) can have the original weight (e.g., a relatively smaller weight). The non-confident area (e.g., the black area in confidence map in FIG. 1E) can have a relatively large weight.

The systems and techniques include and/or implement a Regression Focal Loss to encourage the model to better learn on difficult regions, which is beneficial for cases where both training and test data (partially) come from the same domain. The systems and techniques allow disparity models to achieve better accuracy when comparing to existing lightweight state-of-the-art disparity models, while maintaining computation efficiency.

FIG. 1F illustrates two example images, that may be used to determine depth information according to a depth-from-stereo (DFS) depth-estimation technique. DFS depth-estimation may be an example of a keypoint-matching-based depth-estimation technique.

FIG. 1F illustrates image 116 and image 118 (also denoted in FIG. 1F as image I_{L} and image I_{R}), of a single scene 112 captured from different camera positions, according to various aspects of the present disclosure. The different camera positions are marked as left and right “origin” points, O_{L} and O_{R}, which are offset by a distance Tₓ. Because of the offset Tₓ, the same point P of object 114 appears at different pixel locations p_{L} and p_{R} within the image 116 (I_{L}) and image 118 (I_{R}). As can be seen, the x-axis coordinate x_{R} in image 118 (I_{R}), corresponding to point P_{R} in image 118 (I_{R}), is offset along epi-polar line 120 by disparity d from a coordinate x_{L}, where the coordinate x_{L} corresponds to the position of the point P in the image 116 (I_{L}). This disparity in pixel locations (also referred to as discrepancy) may be used to determine an approximate distance from the cameras to the point P on object 114 in scene 112. By knowing the stereo camera geometry and applying such an analysis to each point in the images, a depth map of the scene may be generated.

In order to determine the disparity d, a system may determine that the pixel location P_{R} in the image 118 (I_{R}) corresponds to the pixel location p_{L} in the image 116 (I_{L}), for example, by comparing a window of pixels including pixels at, and around, the pixel location p_{L} to a number of windows of pixels in image 118 (I_{R}). An example of such a window-based comparison technique is described with respect to FIG. 1G. For example, a passive stereo-vision system may determine epi-polar line 120 in the image 118 (I_{R}). Epi-polar line 120 may be a defined by a ray projected from origin point O_{L} to the point P as viewed in in the image 116 (I_{R}). The passive stereo-vision system may compare the window of pixels including pixels at, and around, the pixel location P_{L} to similarly-sized windows along epi-polar line 120.

FIG. 1G illustrates two example images, image 122 (which may be a “right image” or a “reference image”) and image 124 (which may be a “left image”), and an example associated cost function 134, according to various aspects of the present disclosure. To compare windows between image 122 and image 124, a window 126 of pixels from the image 122 may be selected. Window 126 of pixels from image 122 may be compared to one or more windows of pixels from image 124. In some cases, window 126 may be compared to similarly-sized windows (e.g., all similarly-sized windows) along an epi-polar line 132 of image 124.

The cost function 134 shown in FIG. 1G is representative of a similarity between window 126 and similarly-sized windows along epi-polar line 132 of image 124 as a function of disparity. The similarity between windows may be based on similarities between respective red, green, blue, and/or intensity (or brightness or luminance) values of pixels included in the respective windows. The lower the value of cost function 134 for a particular disparity, the higher the degree of similarity is between window 126 and a window of image 122 at the corresponding disparity. For example, cost function 134 includes two minima, c1 and c2. The minima c1 corresponds to a disparity d1, which corresponds to a comparison between window 126 and candidate window 128 of image 124. The minima c2 corresponds to a disparity d2 which corresponds to a comparison between window 126 and candidate window 130 of image 124.

A disparity map may be a two-dimensional map of disparities. The two-dimensional map may relate to an image (e.g., image 116 of FIG. 1F). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 1F). A depth map may be derived from a disparity map based on the three-dimensional geometry of a scene (e.g., scene 112 of FIG. 1F) including a distance between the cameras which captured the images (e.g., the distance Tₓ of FIG. 1F).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 116 of FIG. 1F). For instance, the depth map may have a resolution that is the same or substantially the same as the corresponding image, with each depth value of the depth map representing a depth, or distance, between an origin point (e.g., origin point O_{L} of FIG. 1F) and points (e.g., point P of FIG. 1F). In some cases, each pixel in the depth map may have one depth value. Because a depth map is based on a disparity map, in some cases, each pixel of a disparity may have one disparity.

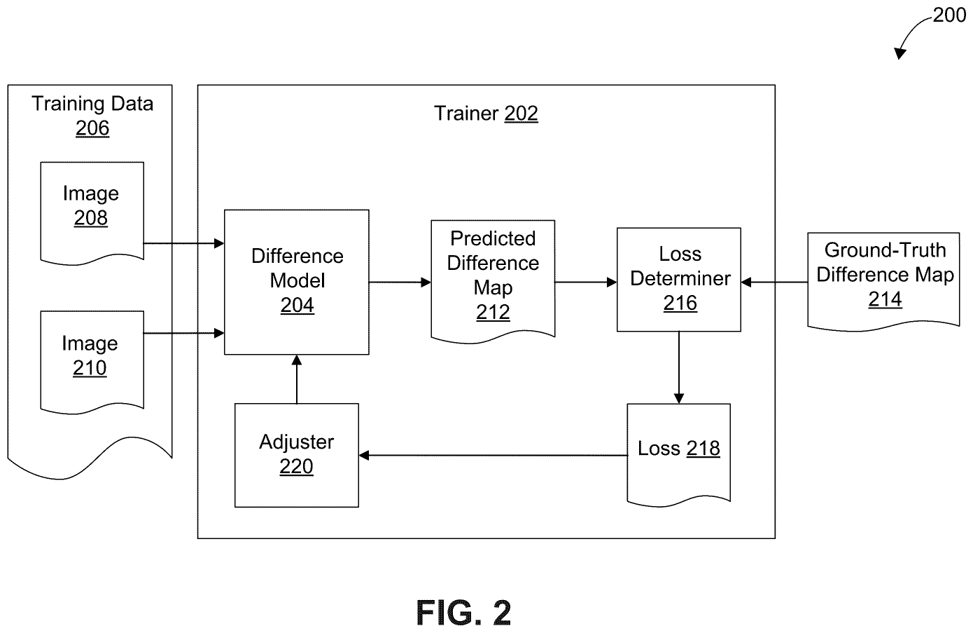

FIG. 2 is a block diagram illustrating an example system 200 that may generate a loss 218 and may train a difference model 204 based on loss 218, according to various aspects of the present disclosure. For example, a trainer 202 of system 200 may train difference model 204 based on training data 206 and ground-truth difference map 214 according to an iterative backpropagation training process. In some aspects, difference model 204 may be, or may include, an optical flow model. In some aspects, difference model 204 may be, or may include, a disparity model.

For example, training data 206 may be, or may include, a corpus of training data including pairs of “adjacent” images. In the present disclosure, the term “adjacent” with reference to images may refer to images that are to be compared by an optical-flow technique or a disparity technique. In the case of optical flow, adjacent images may be captured in close temporal proximity, for example, within less than a second of one another. For example, adjacent images may includes two image frames of video data, one captured immediately after the other. In the case of disparity, adjacent images may be captured from close spatial proximity, for example, within a meter of one another. For example, adjacent images may include images captured at substantially the same time, by a stereoscopic pair of cameras.

In the case of optical flow, image 208 and image 210 are an example pair of adjacent images. Image 208 may have been captured at a first time “t” and image 210 may have been captured at a second time “t+1.” “t+1” may indicate one time step later than “t” and not 1 unit of time later than “t.” For example, image 208 and image 210 may be frames of video data and the video data may have been captured at 30 frames per second (fps). In such a case, image 208 may have been captured at a reference time, “t.” and image 210 may have been captured at “t+1.” In such a case, image 210 may have been captured 1/30th of a second after image 208.

In the case of disparity, image 208 and image 210 are an example pair of adjacent images. Image 208 may have been capture from a first position (e.g., a right position) and image 210 may have been captured from a second position (e.g., a left position). There may be a predetermined distance between the left position and the right position (e.g., 0.1 meters).

Difference model 204 may be, or may include, any suitable machine-learning model. For example, difference model 204 may be, or may include, a convolutional neural network (CNN) or a transformer-based network. Image 208 and image 210 may be provided to difference model 204 as inputs. Difference model 204 may generate predicted difference map 212 based on image 208 and image 210. In some aspects, difference model 204 may be, or may include, an optical flow model. In some aspects, difference model 204 may be, or may include, a disparity model.

Ground-truth difference map 214 may be a ground truth indicative of differences between image 208 and image 210. Ground-truth difference map 214 may be part of, or associated with, training data 206. In some aspects, ground-truth difference map 214 may be, or may include, a ground-truth optical flow map. In some aspects, ground-truth difference map 214 may be, or may include, a ground-truth disparity map.

Loss determiner 216 may compare predicted difference map 212 with ground-truth difference map 214 and determine loss 218 based on differences between predicted difference map 212 and ground-truth difference map 214. In some aspects, loss determiner 216 may determine loss 218 for each pixel according to:

∥f_{gt}−f_{pred}∥₁
where f_{gt} represents a ground-truth optical flow or ground-truth disparity map for a given pixel (e.g., of ground-truth difference map 214); and
where f_{pred} represents a predicted optical flow or predicted disparity map for a given pixel (e.g., of predicted difference map 212).

In total, loss determiner 216 may determine loss 218 as:

$${L}_{total} = {\sum }_{i = 1}^{N} {γ}^{N - i} {‖ {f}_{gt} - {f}_{p r e d} ‖}_{1}$$

where N is the number of pixels of image 208; and
where γ is a hyperparameter.

Adjuster 220 may adjust parameters (e.g., weights) of difference model 204 based on loss 218 such that difference model 204 may predict predicted difference map 212 to be more like ground-truth difference map 214 in future iterations of the iterative training process. For example, adjuster 220 may adjust the parameters of difference model 204 according to a gradient descent technique. Initially, predicted difference map 212 may be dissimilar from ground-truth difference map 214. However, through many iterations of the training process, predicted difference map 212 may become more like ground-truth difference map 214.

Once trained, difference model 204 may be used to infer difference maps (e.g., optical flows or disparity maps) based on pairs of adjacent images. Once trained, difference model 204 may be used in, for example, automated driving of a vehicle, assisted driving of a vehicle, extended reality (XR) (including augmented reality (AR), and virtual reality (VR)) or a camera. Difference model 204 may be used in for many tasks, including, as examples, video processing, temporal information aggregation, tracking, etc.

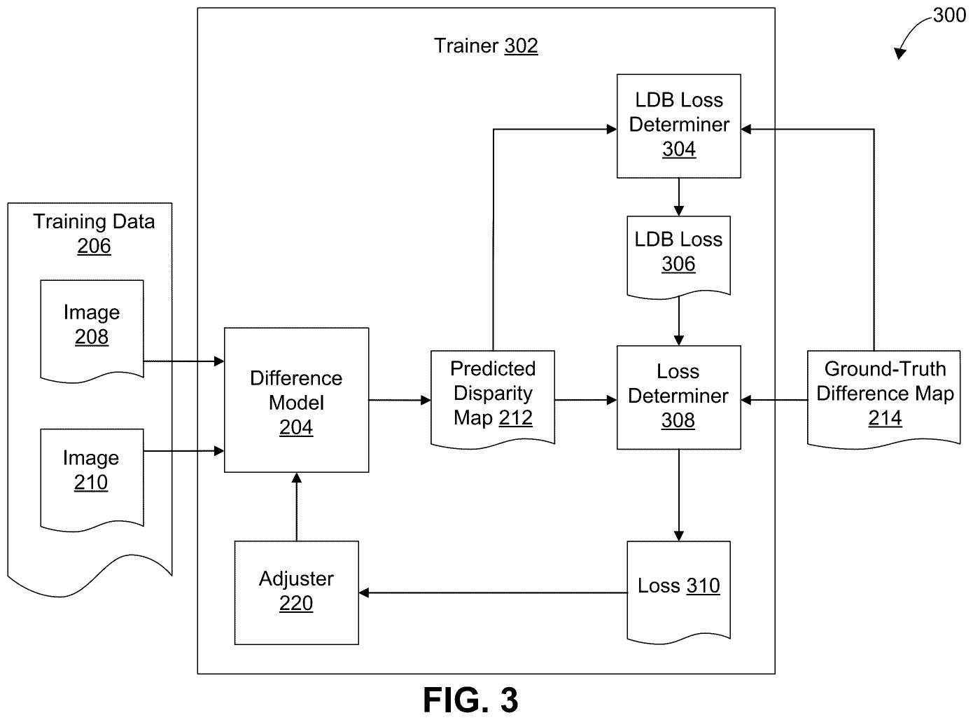

FIG. 3 is a block diagram illustrating an example system 300 that may generate a loss 310 and may train a difference model 204 based on loss 310, according to various aspects of the present disclosure. For example, a trainer 302 of system 300 may train difference model 204 based on training data 206 and ground-truth difference map 214 according to an iterative backpropagation training process. The iterative backpropagation training process of trainer 302 may be similar to the iterative backpropagation process described with regard to trainer 202 of FIG. 2.

Additionally, trainer 302 includes a learning difficulty balancing (LDB) loss determiner 304 that may determine LDB loss 306 based on predicted difference map 212 and ground-truth difference map 214. LDB loss determiner 304 may determine LDB loss 306 for each pixel according to:

$${M}_{c o n f}^{L} ( x ) = {e}^{- {‖ {u}_{g t} ( x ) - u ( x ) ‖}^{2}}$$

where M_{conf}^{L} represents a confidence for the optical flow or predicted disparity map for the pixel;
where x represents a given pixel
where u_{gt}(x) represents the ground-truth optical flow or predicted disparity map for the given pixel x; and
where u(x) represents the predicted optical flow or predicted disparity map for the given pixel x.
M_{conf}^{L} may represent a confidence map indicating a confidence relative to predictions for given pixels of a predicted optical flow or predicted disparity map.

Similar to loss determiner 216 of FIG. 2, loss determiner 308 of trainer 302 may determine loss 310 based on predicted difference map 212 and ground-truth difference map 214. Further, loss determiner 308 may determine loss 310 based on LDB loss 306. For example, loss determiner 308 may determine loss 310 based on:

$${L}_{total}^{L} = {\sum }_{i = 1}^{N} {γ}^{N - i} {‖ ( 1 + α \cdot {( 1 - {M}_{c o n f}^{L} )}^{γ} ) \cdot ( {f}_{gt} - {f}_{p r e d} ) ‖}_{1}$$

where Lₜₒₜₐₗ^{L} represents the total loss (e.g., loss 310);
where γ is a hyperparameter; and
where α is a hyperparameter.

Adjuster 220 may adjust parameters (e.g., weights) of difference model 204 based on loss 310. By training difference model 204 based on LDB loss 306 (in addition to a loss based on a difference between predicted difference map 212 and ground-truth difference map 214), trainer 302 may train difference model 204 with more emphasis on difficult pixels.

M_{conf}^{L} may be based on a difference between predicted difference map 212 and ground-truth difference map 214. Pixels with a relatively large difference between predicted difference map 212 and ground-truth difference map 214 may result in relatively low confidence values in M_{conf}^{L} and pixels with a relatively small difference between predicted difference map 212 and ground-truth difference map 214 may result in relatively high confidence values. M_{conf}^{L} may include a value between 0 and 1, with 0 corresponding to a low confidence and 1 corresponding to a high confidence. (1−M_{conf}^{L}) may be the inverse with 0 corresponding to high confidence and 1 corresponding to low confidence. As such, for pixel values (x) corresponding to a high confidence, (1−M_{conf}^{L}) may be close to zero and the total loss may be based on (f_{gt}−f_{pred}). However, for pixel values (x) corresponding to low confidence, (1−M_{conf}^{L}) may be non-zero and the total loss may be scaled by α·(1−M_{conf}^{L})^{γ}. Further, loss for low-confidence pixels may be higher than loss for high-confidence pixels. Scaling loss 310 based on the confidence map (e.g., proportional to the inverse of the confidence map) may improve the training of difference model 204 for low-confidence pixels.

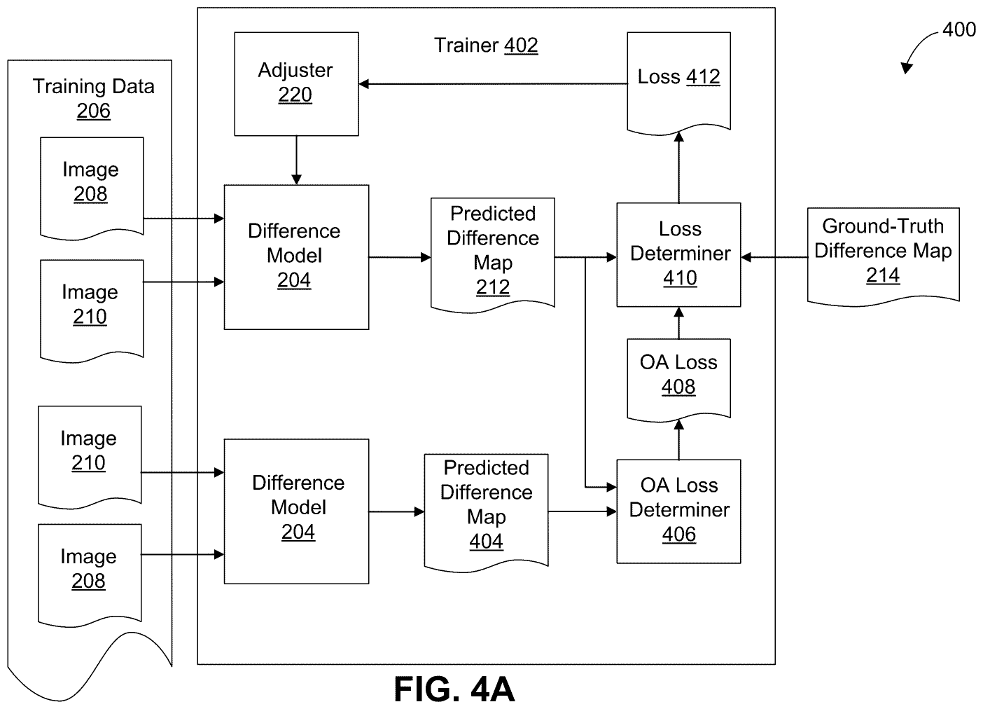

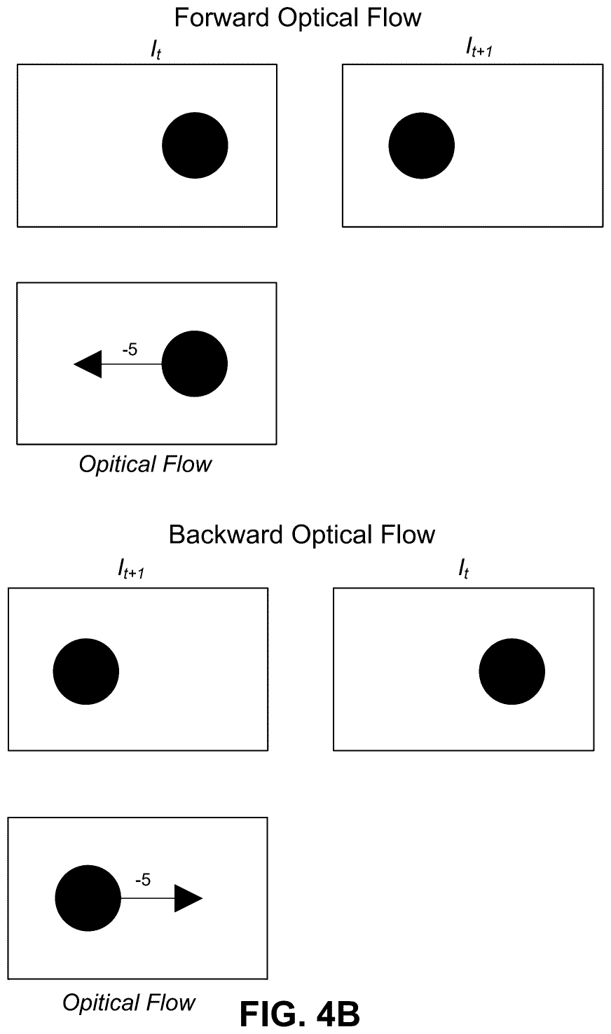

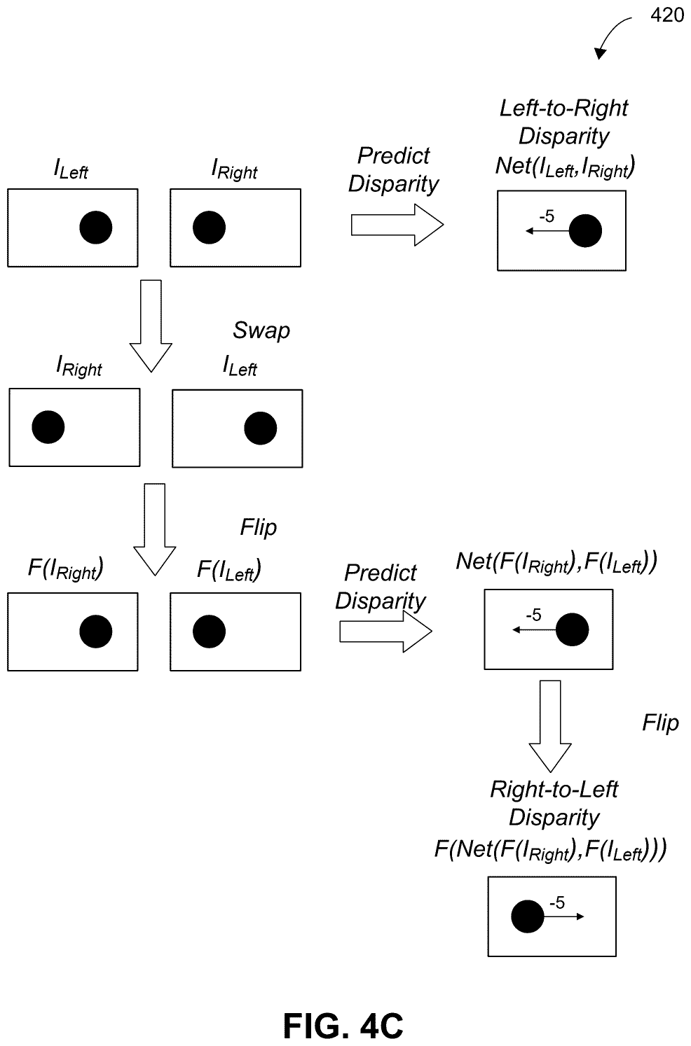

FIG. 4A is a block diagram illustrating an example system 400 that may generate a loss 412 and may train a difference model 204 based on loss 412, according to various aspects of the present disclosure. For example, a trainer 402 of system 400 may train difference model 204 based on training data 206 and ground-truth difference map 214 according to an iterative backpropagation training process. The iterative backpropagation training process of trainer 402 may be similar to the iterative backpropagation process described with regard to trainer 202 of FIG. 2.

Additionally, trainer 402 includes an occlusion avoiding (OA) loss determiner 406 that may determine OA loss 408 based on predicted difference map 212 and predicted difference map 404. In the case of optical flow, in trainer 402, difference model 204 may predict a forward optical flow (predicted difference map 212) based on a difference between image 208 and image 210. Additionally, difference model 204 may predict a backward optical flow (e.g., predicted difference map 404) based on a difference between image 210 and image 208. The forward optical flow may be an optical flow considered forward in time, for example, a difference between a first-captured image (e.g., image 208) and a second-captured image (e.g., image 210). The backward optical flow may be an optical flow considered backward in time, for example, a difference between a second-captured image (e.g., image 210) and a first-captured image (e.g., image 208).

In the case of disparity, in trainer 402, difference model 204 may predict a first-to-second disparity map (predicted difference map 212) based on a difference between image 208 and image 210. Additionally, difference model 204 may predict a second-to-first disparity map (e.g., predicted difference map 404) based on a difference between image 210 and image 208. The first-to-second disparity map may be based on a difference between an image captured from a first position (e.g., image 208) and an image captured from a second position (e.g., image 210). The second-to-first disparity map may be based on a difference between an image captured from the second position (e.g., image 210) and an image captured from the first position (e.g., image 208).

OA loss determiner 406 may determine OA loss 408 based on predicted difference map 212 and predicted difference map 404. In the case of optical flow, conceptually, predicted difference map 212 may include vectors for pixels describing motion between image 208 and image 210. Predicted difference map 404 may include vectors for pixels describing motion between image 210 and image 208. Thus, predicted difference map 404 may be substantially the opposite (e.g., each vector of predicted difference map 404 may be the opposite a corresponding vector of predicted difference map 212) of predicted difference map 212.

FIG. 4B illustrates a forward optical flow between an image Iₜ and an image Iₜ₊₁ and a backward optical flow between an image Iₜ₊₁ and an image Iₜ, according to various aspects of the present disclosure. In the example forward optical flow, the optical flow is −5—indicating the image feature moved 5 to the left between the image Iₜ and an image Iₜ₊₁. In the example backward optical flow, the optical flow is 5—indicating the image feature moved 5 to the right between the image Iₜ₊₁ and an image Iₜ.

Returning to FIG. 4A, OA loss determiner 406 may determine OA loss 408 based on differences between the opposite of predicted difference map 212 and predicted difference map 404. In the case of optical flow, OA loss determiner 406 may determine OA loss 408 based on a forward optical flow and a backward optical flow (e.g., as illustrated and described with regard to FIG. 4B). For example, OA loss determiner 406 may determine OA loss 408 according to:

$${M}_{c o n f}^{D} ( x ) = exp ( - \frac{{\vert {\hat{V}}^{f} ( x ) + {\hat{V}}^{b} ( x + {\hat{V}}^{f} ( x ) ) \vert}^{2}}{{γ}_{1} ( {\vert {\hat{V}}^{f} \vert}^{2} + {\vert {\hat{V}}^{b} ( x + {\hat{V}}^{f} ( x ) ) \vert}^{2} ) + {γ}_{2}} )$$

where M_{conf}^{D}(x) represents the confidence of a given pixel x;
where \hat{V}^{f}(x) represents a forward optical flow vector for the given pixel (e.g., an optical flow from image 208 to image 210);
where \hat{V}^{b}(x) represents a backward optical flow vector for the given pixel (e.g., an optical flow from image 210 to image 208); and
where γ₁ and γ₂ are hyperparameters.

In the case of disparity, conceptually, predicted difference map 212 may include disparity values describing differences between image 208 and image 210 (e.g., based on depths to points in the scene represented by image 208 and image 210). Predicted difference map 404 may include disparity values describing differences between image 210 and image 208. Thus, predicted difference map 404 may be substantially the opposite (e.g., each disparity value of predicted difference map 404 may be the opposite a corresponding disparity value of predicted difference map 212) of predicted difference map 212.

Unlike optical flow and motion vectors, disparity models may be unidirectional. For example, a disparity model may determine the disparity between a left image and a right image but not the disparity between a right image and a left image. Therefore, in order to determine the second-to-first disparity, the images may need to be flipped prior to comparing the images using the disparity model.

FIG. 4C illustrates a process 420 for determining a left-to-right disparity and a right-to-left disparity, according to various aspects of the present disclosure. Process 420 may begin with obtaining a first image—I_{Left} and a second image—I_{Right}. Image I_{Left} may be obtained by a first camera (e.g., a left camera) of a stereoscopic pair of cameras and image I_{Right} may be obtained by a second camera (e.g., a right camera) of the stereoscopic pair of cameras. Image I_{Left} and image I_{Right} may be obtained at substantially the same time.

Process 420 may include generating a left-to-right disparity by providing image I_{L}et and image I_{Right} to a disparity network (denoted as Net(I_{Left}, I_{Right})). The disparity network may be trained to generate disparity based on pairs of stereoscopic images. In the example left-to-right disparity, the disparity is −5—indicating the image feature is 5 to the left in image I_{Right} as compared with image I_{Left}.

Additionally, Process 420 may include swapping I_{Left} and image I_{Right} and flipping (about a vertical axis) I_{Left} and image I_{Right} (denoted as F(I_{Right}) and F(I_{Left}) respectively). Process 420 may include generating an intermediate disparity by providing the flipped and swapped images (F(I_{Right}) and F(I_{Left})) to the disparity network (denoted as Net(F(I_{Right}), F(I_{Left})). In the example intermediate disparity, the disparity is −5—indicating the image feature is 5 to the left in image F(I_{Left}) as compared with image F(I_{Right}). Process 420 may include flipping the intermediate disparity to generate the right-to-left disparity (denoted as F(Net(F(I_{Right}), F(I_{Left})))). Once flipped, the disparity is 5 indicating the image feature is 5, which is the opposite of the left-to-right disparity of the image feature. Thus, process 420 generates a left-to-right disparity and a right-to-left disparity using the same disparity net.

Returning to FIG. 4A, OA loss determiner 406 may determine OA loss 408 based on differences between the opposite of predicted difference map 212 and predicted difference map 404. In the case of disparity, OA loss determiner 406 may determine OA loss 408 based on a left-to-right disparity and a right-to-left disparity (e.g., as illustrated and described with regard to FIG. 4C). For example, OA loss determiner 406 may determine OA loss 408 according to:

$${M}_{conf}^{D} ( x ) = exp ( - \frac{{\vert {\hat{V}}^{fts} ( x ) + {\hat{V}}^{stf} ( x + {\hat{V}}^{fts} ( x ) ) \vert}^{2}}{{γ}_{1} ( {\vert {\hat{V}}^{fts} \vert}^{2} + {\vert {\hat{V}}^{stf} ( x + {\hat{V}}^{fts} ( x ) ) \vert}^{2} ) + {γ}_{2}} )$$

where M_{conf}^{D}(x) represents the confidence of a given pixel x;
where \hat{V}^{fts}(x) represents a first-to-second disparity for the given pixel (e.g., disparity values from image 208 to image 210);
where \hat{V}^{stf}(x) represents a second-to-first disparity for the given pixel (e.g., disparity values from image 210 to image 208); and
where γ₁ and γ₂ are hyperparameters.

In either the case of optical flow or the case of disparity, similar to loss determiner 216 of FIG. 2, loss determiner 410 of trainer 402 may determine loss 412 based on predicted difference map 212 and ground-truth difference map 214. Further, loss determiner 410 may determine loss 412 based on OA loss 408. For example, loss determiner 410 may determine loss 412 based on:

$${L}_{total}^{D} = {\sum }_{i = 1}^{N} {γ}^{N - i} {‖ ( 1 + α \cdot {( {M}_{conf}^{D} )}^{γ} ) \cdot ( {f}_{gt} - {f}_{pred} ) ‖}_{1}$$

where Lₜₒₜₐₗ^{D} represents the total loss (e.g., loss 412);
where γ is a hyperparameter; and
where α is a hyperparameter.

Adjuster 220 may adjust parameters (e.g., weights) of difference model 204 based on loss 412. By training difference model 204 based on OA loss 408 (in addition to a loss based on a difference between predicted difference map 212 and ground-truth difference map 214), trainer 402 may reduce training of difference model 204 for occlusion areas which may not contain useful cues to estimate optical flows (e.g., based on the occlusion precluding the cues for estimating optical flows).

For example, in the case of optical flow, M_{conf}^{D}(x) will be high when an optical flow calculated between image 208 and image 210 is the opposite from an optical flow calculated between image 210 and image 208. In cases where objects are occluded, an optical flow calculated between image 208 and image 210 will be different from the opposite of an optical flow calculated between image 210 and image 208. As such, M_{conf}^{D}(x) will be high for non-occluded pixels and low for occluded pixels.

In the case of disparity, M_{conf}^{D}(x) will be high when left-to-right disparity calculated between image 208 and image 210 is the opposite from a right-to-left disparity calculated between image 210 and image 208. In cases where objects are occluded, left-to-right disparity calculated between image 208 and image 210 will be different from the opposite of a right-to-left disparity calculated between image 210 and image 208. As such, M_{conf}^{D}(x) will be high for non-occluded pixels and low for occluded pixels.

In either the case of optical flow or the case of disparity, when M_{conf}^{D}(x) is high, the loss will be high for the pixel—encouraging learning based on a high loss. However, when M_{conf}^{D}(x) is low (e.g., near zero), the loss will be low for the pixel—which may tend to not encourage learning.

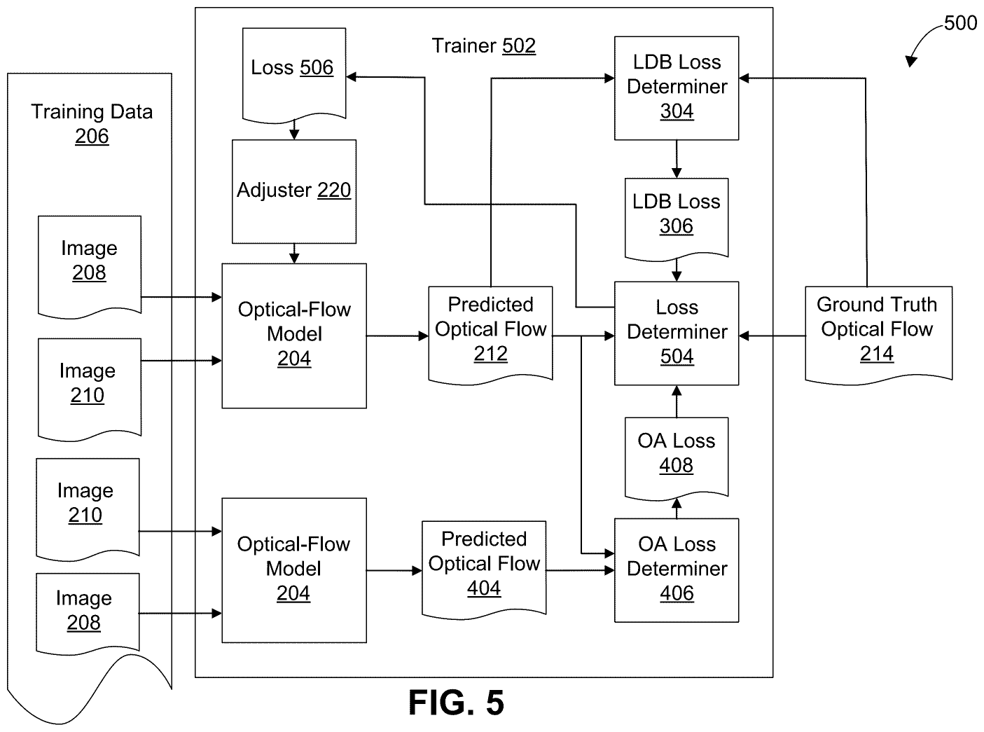

FIG. 5 is a block diagram illustrating an example system 500 that may generate a loss 506 and may train a difference model 204 based on loss 506, according to various aspects of the present disclosure. For example, a trainer 502 of system 500 may train difference model 204 based on training data 206 and ground-truth difference map 214 according to an iterative backpropagation training process. The iterative backpropagation training process of trainer 502 may be similar to the iterative backpropagation process described with regard to trainer 202 of FIG. 2.

Additionally, trainer 502 includes LDB loss determiner 304 of FIG. 3, which may determine LDB loss 306 of FIG. 3. Additionally, trainer 502 includes OA loss determiner 406 of FIG. 4A, which may determine OA loss 408 of FIG. 4A.

Similar to loss determiner 216 of FIG. 2, loss determiner 504 of trainer 502 may determine loss 506 based on predicted difference map 212 and ground-truth difference map 214. Further, loss determiner 504 may determine loss 506 based on OA loss 408 and LDB loss 306.

In determining loss 506 based on LDB loss 306 and OA loss 408, loss 506 may combine a loss based on predicted difference map 212 and ground-truth difference map 214, LDB loss 306, and OA loss 408 in one of several ways. For example, loss determiner 504 may combine LDB loss 306 with OA loss 408 in an additive fashion, a multiplicative fashion, a mask-based fashion, or a mask-and-additive-based fashion.

For example, according to a first aspect, loss determiner 504 may determine loss 506 by combining LDB loss 306 and OA loss 408 in an additive fashion, for example, according to:

$${l}_{sum}^{i} = {‖ ( 1 + {α}_{1} \cdot {( 1 - {M}_{LDB} )}^{{β}_{1}} + {α}_{2} \cdot {( {M}_{OA} )}^{{β}_{2}} ) \cdot ( {f}_{gt} - {f}_{1 -> 2}^{i} ) ‖}_{1}$$

where lₛᵤₘⁱ represents the total loss;
where M_{LDB} represents the LDB loss;
where M_{OA} represents the OA loss;
where f_{gt} represents the ground-truth difference map (e.g., the ground-truth optical flow or the ground-truth disparity map);
where f_{1->2}ⁱ represents the predicted difference map (e.g., the predicted optical flow or ht predicted disparity map); and
where α₁, α₂, β₁, and β₂ are all hyperparameters.

For example, loss determiner 504 may additively sum 1, α₁·(1−M_{LDB})^{β}^{₁}, and α₂·(M_{OA})^{β}^{₂}, and multiply the sum by (f_{gt}−f_{1->2}ⁱ).

As another example, according to a second aspect, loss determiner 504 may determine loss 506 by combining LDB loss 306 and OA loss 408 in a multiplicative fashion, for example, according to:

$${l}_{mul}^{i} = {‖ ( 1 + {α}_{1} \cdot {( 1 - {M}_{LDB} )}^{{β}_{1}} + {α}_{2} \cdot {( {M}_{OA} )}^{{β}_{2}} ) \cdot ( {f}_{gt} - {f}_{1 -> 2}^{i} ) ‖}_{1}$$

where lₘᵤₗⁱ represents the total loss;
where M_{LDB} represents the LDB loss;
where M_{OA} represents the OA loss;
where f_{gt} represents the ground-truth difference map (e.g., the ground-truth optical flow or the ground-truth disparity map);
where f_{1->2}ⁱ represents the predicted difference map (e.g., the predicted optical flow or ht predicted disparity map); and
where α₁, α₂, β₁, and β₂ are all hyperparameters.

For example, loss determiner 504 may multiply α₂·(M_{conf}^{D})^{γ}^{₂} with (1+α₁·(1−M_{conf}^{L})^{γ}^{₁}), add 1 and multiply the result by (f_{gt}−f_{pred}).

As another example, according to a third aspect, loss determiner 504 may determine loss 506 by combining LDB loss 306 and OA loss 408 in a mask-based fashion, for example, according to:

$${l}_{mask}^{i} = {‖ ( 1 + H ( {M}_{OA} ) \cdot {α}_{1} \cdot {( 1 - {M}_{LDB} )}^{{β}_{1}} ) \cdot ( {f}_{gt} - {f}_{1 -> 2}^{i} ) ‖}_{1}$$

where lₘₐₛₖⁱ represents the total loss;
where M_{OA} represents a mask based on the OA loss;
where M_{LDB} represents a mask based on the LBD loss;
where f_{gt} represents the ground-truth difference map (e.g., the ground-truth optical flow or the ground-truth disparity map);
where f_{1->2}ⁱ represents the predicted difference map (e.g., the predicted optical flow or ht predicted disparity map); and
where H, α₁, α₂, β₁, and β₂ are all hyperparameters.

For example, OA loss determiner 406 or loss determiner 504 may determine M_{OA}—a mask based on OA loss 408. M_{OA} may be determined based on OA loss 408 based on whether values of OA loss 408 exceed a threshold. Values that exceed the threshold may result in is in the mask and values that do not exceed the threshold may result in 0s in the mask. Similarly, LDB loss determiner 304 or loss determiner 504 may determine M_{LDB}—a mask based on LDB loss 306. M_{LDB} may be based on LDB loss 306 based on whether values of LDB loss 306 exceed a threshold. Values that exceed the threshold may result in is in the mask and values that do not exceed the threshold may result in 0s in the mask. Loss determiner 504 may determine lₘₐₛₖⁱ based on M_{OA} and M_{LDB}.

As another example, according to a fourth aspect, loss determiner 504 may determine loss 506 by combining LDB loss 306 and OA loss 408 in a mask-and-additive-based fashion, for example, according to:

$${l}_{mask ‐ sum}^{i} = {‖ ( 1 + H ( {M}_{OA} ) \cdot {α}_{1} \cdot {( 1 - {M}_{LDB} )}^{{β}_{1}} + {{α}_{2} ( {M}_{OA} )}^{{β}_{2}} ) ( {f}_{gt} - {f}_{1 -> 2}^{i} ) ‖}_{1}$$

where lₘₐₛₖ₋ₛᵤₘⁱ represents the total loss;
where M_{OA} represents a mask based on the OA loss;
where M_{LDB} represents a mask based on the LBD loss;
where f_{gt} represents the ground-truth difference map (e.g., the ground-truth optical flow or the ground-truth disparity map);
where f_{1>2}ⁱ represents the predicted difference map (e.g., the predicted optical flow or ht predicted disparity map); and
where H, α₁, α₂, β₁, and β₂ are all hyperparameters.

For example, OA loss determiner 406 or loss determiner 504 may determine M_{OA}—a mask based on OA loss 408. M_{OA} may be determined based on OA loss 408 based on whether values of OA loss 408 exceed a threshold. Values that exceed the threshold may result in is in the mask and values that do not exceed the threshold may result in 0s in the mask. Similarly, LDB loss determiner 304 or loss determiner 504 may determine M_{LDB}—a mask based on LDB loss 306. M_{LDB} may be based on LDB loss 306 based on whether values of LDB loss 306 exceed a threshold. Values that exceed the threshold may result in is in the mask and values that do not exceed the threshold may result in 0s in the mask. Loss determiner 504 may determine lₘₐₛₖⁱ based on M_{OA} and M_{LDB}.

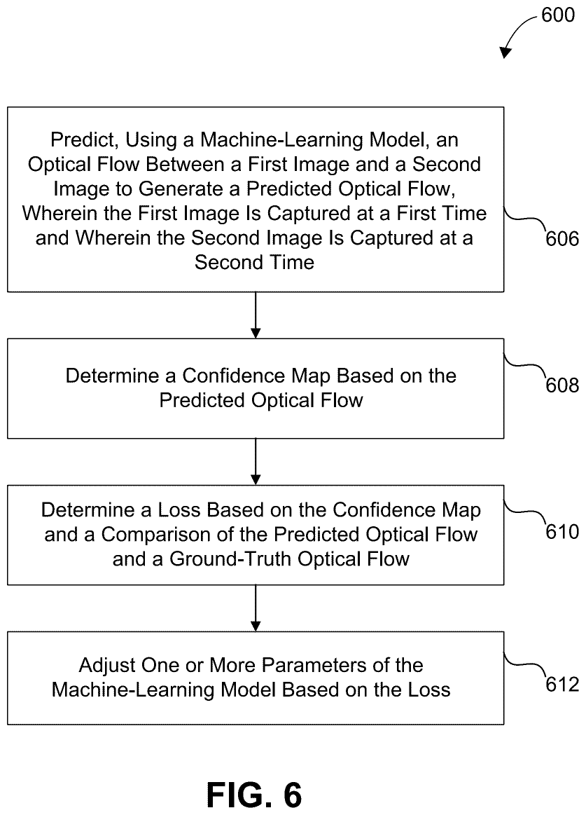

FIG. 6 is a flow diagram illustrating an example process 600 for determining an error (e.g., a loss) and training an optical-flow model based on the error, in accordance with aspects of the present disclosure. One or more operations of process 600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 600. The one or more operations of process 600 may be implemented as software components that are executed and run on one or more processors. As an example, process 600 may be implemented by system 300 of FIG. 3, by system 400 or FIG. 4A, and/or by system 500 of FIG. 5.

At block 606, a computing device (or one or more components thereof) may predict, using a machine-learning model, an optical flow between a first image and a second image to generate a predicted optical flow. The first image may be captured at a first time. The second image may be captured at a second time. For example, trainer 302 of FIG. 3, trainer 402 of FIG. 4A, or trainer 502 of FIG. 5 may obtain image 208 and image 210 of training data 206 of FIG. 3, FIG. 4A, or FIG. 5. Additionally, difference model 204 of FIG. 3, FIG. 4A, or FIG. 5 may predict predicted difference map 212 of FIG. 3, FIG. 4A, or FIG. 5.

In some aspects, the first image and the second image may be captured by a camera (e.g., the same camera). In some aspects, the computing device (or one or more components thereof) may include the camera or a device may include the computing device (or one or more components thereof) and the camera.

At block 608, the computing device (or one or more components thereof) may determine a confidence map based on the predicted optical flow. For example, LDB loss determiner 304 of FIG. 3 or FIG. 5 may determine LDB loss 306 of FIG. 3 or FIG. 5 based on predicted difference map 212. As another example, OA loss determiner 406 of FIG. 4A or FIG. 5 may determine OA loss 408 of FIG. 4A or FIG. 5 based on predicted difference map 212.

At block 610, the computing device (or one or more components thereof) may determine an error based on the confidence map and a comparison of the predicted optical flow and the ground-truth optical flow. For example, loss determiner 308 of FIG. 3 may determine loss 310 of FIG. 3 based on predicted difference map 212 and LDB loss 306. As another example, loss determiner 410 of FIG. 4A may determine loss 412 of FIG. 4A based on predicted difference map 212 and OA loss 408. As another example, loss determiner 504 of FIG. 5 may determine loss 506 based on predicted difference map 212, LDB loss 306, and OA loss 408.

In some aspects, the confidence map (e.g., determined at block 608) may be a learning-difficulty-balance confidence map. For example, LDB loss 306 may be, or may include, a learning-difficulty-balance confidence map.

In some aspects, the error is determined based on the confidence map to increase error values for high-confidence pixels and to decrease error values for low-confidence pixels. In some aspects, the computing device (or one or more components thereof) may determine the confidence map based on a comparison of the predicted optical flow with the ground-truth optical flow. For example, LDB loss determiner 304 may determine LDB loss 306 based on a comparison between predicted difference map 212 and ground-truth difference map 214.

In some aspects, a large difference (e.g., a relatively large difference) between a first pixel of the predicted optical flow and a corresponding pixel of the ground-truth optical flow relates to a low value (e.g., a relatively low value) in the confidence map. A small difference (e.g., relatively small difference) between a second pixel of the predicted optical flow and a corresponding pixel of the ground-truth optical flow relates to a high value (e.g., a relatively high value) in the confidence map.

In some aspects, the computing device (or one or more components thereof) may determine the confidence map (e.g., at block 608) according to:

$${M}_{conf}^{L} ( x ) = {e}^{- {‖ {u}_{gt} ( x ) - u ( x ) ‖}^{2}}$$

where M_{conf}^{L} represents the confidence map;
where x represents a given pixel;
where u_{gt}(x) represents the ground-truth optical flow for the given pixel x; and
where u(x) represents the predicted optical flow for the given pixel x.

In some aspects, the computing device (or one or more components thereof) may determine a loss (e.g., as an example of an error) according to:

$${L}_{total}^{L} = {\sum }_{i = 1}^{N} {γ}^{N - i} {‖ ( 1 + α \cdot {( 1 - {M}_{conf}^{L} )}^{γ} ) \cdot ( {f}_{gt} - {f}_{pred} ) ‖}_{1}$$

where Lₜₒₜₐₗ^{L} represents the loss;
where γ is a hyperparameter; and
where α is a hyperparameter.

In some aspects, the confidence map (e.g., determined at block 608) may be, or may include, an occlusion-based confidence map. For example, OA loss 408 may be, or may include, an occlusion-based confidence map.

In some aspects, the error (e.g., the loss) may be determined based on an inverse of the confidence map to increase error values (e.g., loss values) for low-confidence pixels and to decrease error values (e.g., loss values) for high-confidence pixels.

In some aspects, the computing device (or one or more components thereof) may predict, using the machine-learning model, the forward optical flow between the first image and the second image; and predict, using the machine-learning model, the backward optical flow between the second image and the first image. For example, difference model 204 of FIG. 4A and FIG. 5 may generate predicted difference map 212 based on image 208 and image 210. Additionally, 204 of FIG. 4A and FIG. 5 may generate predicted difference map 404 based on image 210 and image 208.

In some aspects, a small difference (e.g., a relatively small difference) between a first forward vector between the first image and the second image and an inverse of a first backward vector between the second image and the first image relates to a high value (e.g., a relatively high value) in the confidence map. A large difference (e.g., a relatively large difference) between a second forward vector between the first image and the second image and the inverse of a second backward vector between the second image and the first image relates to a low value (e.g., a relatively low value) in the confidence map.

In some aspects, the computing device (or one or more components thereof) may determine the occlusion-based confidence map based on a forward optical flow between the first image and the second image and backward optical flow between the second image and the first image. For example, OA loss determiner 406 may determine OA loss 408 based on predicted difference map 212 and predicted difference map 404 of FIG. 4A or FIG. 5.

In some aspects, the computing device (or one or more components thereof) may determine the occlusion-based confidence map according to:

$${M}_{conf}^{D} ( x ) = exp ( - \frac{{\vert {\hat{V}}^{f} ( x ) + {\hat{V}}^{b} ( x + {\hat{V}}^{f} ( x ) ) \vert}^{2}}{{γ}_{1} ( {\vert {\hat{V}}^{f} \vert}^{2} + {\vert {\hat{V}}^{b} ( x + {\hat{V}}^{f} ( x ) ) \vert}^{2} ) + {γ}_{2}} )$$

where M_{conf}^{D}(x) represents a confidence of a given pixel x;
where \hat{V}^{f}(x) represents a forward optical flow vector for the given pixel;
where \hat{V}^{b}(x) represents a backward optical flow vector for the given pixel; and
where γ₁ and γ₂ are hyperparameters.

In some aspects, the computing device (or one or more components thereof) may determine a loss (e.g., as an example of an error) according to:

$${L}_{total}^{D} = {\sum }_{i = 1}^{N} {γ}^{N - i} {‖ ( 1 + α \cdot {( {M}_{conf}^{D} )}^{γ} ) \cdot ( {f}_{gt} - {f}_{pred} ) ‖}_{1}$$

where Lₜₒₜₐₗ^{D} represents the loss;
where γ is a hyperparameter; and
where α is a hyperparameter.

In some aspects, to determine the confidence map, the one or more processors are configured to: determine a learning-difficulty-balance confidence map based on a comparison of the predicted optical flow with the ground-truth optical flow; and determine an occlusion-based confidence map based on the first image and the second image. The error (e.g., the loss) may be determined based on the learning-difficulty-balance confidence map and the occlusion-based confidence map. For example, LDB loss determiner 304 of FIG. 5 may determine LDB loss 306, OA loss determiner 406 of FIG. 5 may determine OA loss 408, and loss determiner 504 of FIG. 5 may determine loss 506 based on predicted difference map 212, ground-truth difference map 214, LDB loss 306, and OA loss 408.

In some aspects, the computing device (or one or more components thereof) may determine the error (e.g., the loss) according to:

In some aspects, the computing device (or one or more components thereof) may determine a loss (e.g., as an example of the error) according to:

$${L}_{total} = {\sum }_{i = 1}^{N} {γ}^{N - i} {‖ ( 1 + {α}_{1} \cdot {( 1 - {M}_{conf}^{L} )}^{{γ}_{1}} + {α}_{2} \cdot {( {M}_{conf}^{D} )}^{{γ}_{2}} ) \cdot ( {f}_{gt} - {f}_{pred} ) ‖}_{1}$$

where Lₜₒₜₐₗ represents the loss;
where M_{conf}^{L} represents the first confidence map;
where M_{conf}^{D}(x) represents the occlusion-based confidence map;
where f_{gt} represents the ground-truth optical flow;
where f_{pred} represents the predicted optical flow; and
where α₁, α₂, γ₁, and γ₂ are hyperparameters.

In some aspects, the computing device (or one or more components thereof) may determine a loss (e.g., as an example of the error) according to:

$${L}_{total} = {\sum }_{i = 1}^{N} {γ}^{N - i} {‖ ( 1 + {α}_{2} \cdot {( {M}_{conf}^{D} )}^{{γ}_{2}} ( 1 + {α}_{1} \cdot {( 1 - {M}_{conf}^{L} )}^{{γ}_{1}} ) ) \cdot ( {f}_{gt} - {f}_{pred} ) ‖}_{1}$$

where Lₜₒₜₐₗ represents the loss;
where M_{conf}^{L} represents the first confidence map;
where M_{conf}^{D}(x) represents the occlusion-based confidence map;
where f_{gt} represents the ground-truth optical flow;
where f_{pred} represents the predicted optical flow; and
where α₁, α₂, γ₁, and γ₂ are hyperparameters.

In some aspects, the error (e.g., the loss) may be determined based on an inverse of the learning-difficulty-balance confidence map to increase error values (e.g., loss values) for low-confidence pixels of the learning-difficulty-balance confidence map and to decrease error values (e.g., loss values) for high-confidence pixels of the learning-difficulty-balance confidence map. Additionally or alternatively, the error may be determined based on the occlusion-based confidence map to increase error values for high-confidence pixels of the occlusion-based confidence map and to decrease error values for low-confidence pixels of the occlusion-based confidence map.

At block 612, the computing device (or one or more components thereof) may adjust one or more parameters of the machine-learning model based on the error (e.g., the loss). For example, adjuster 220 of FIG. 3, FIG. 4A, or FIG. 5 may adjust one or more parameters (e.g., weights) of difference model 204 based on loss 310 of FIG. 3, loss 412 of FIG. 4A, or loss 506 of FIG. 5.

In some aspects, the computing device (or one or more components thereof) may adjust the at least one parameter on the apparatus in an online training process.

In some aspects, the computing device (or one or more components thereof) may cause at least one image to be displayed based on an optical-flow prediction from the machine-learning model.

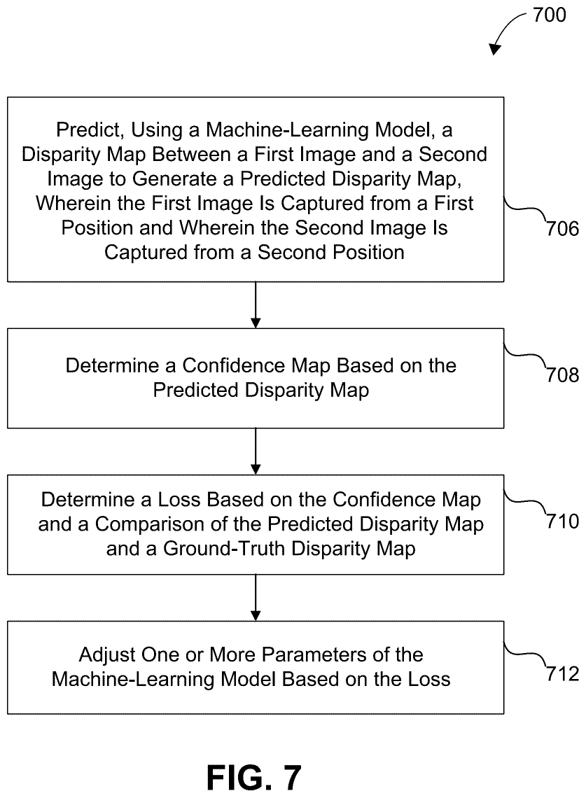

FIG. 7 is a flow diagram illustrating an example process 700 for determining an error (e.g., a loss) and training an optical-flow model based on the error, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 700. The one or more operations of process 700 may be implemented as software components that are executed and run on one or more processors. As an example, process 600 may be implemented by system 300 of FIG. 3, by system 400 or FIG. 4A, and/or by system 500 of FIG. 5.

At block 706, a computing device (or one or more components thereof) may predict, using a machine-learning model, a disparity map between a first image and a second image to generate a predicted disparity map. The first image may be captured from a first position. The second image may be captured from a second position. For example, trainer 302 of FIG. 3, trainer 402 of FIG. 4A, or trainer 502 of FIG. 5 may obtain image 208 and image 210 of training data 206 of FIG. 3, FIG. 4A, or FIG. 5. Additionally, difference model 204 of FIG. 3, FIG. 4A, or FIG. 5 may predict predicted difference map 212 of FIG. 3, FIG. 4A, or FIG. 5.

In some aspects, the first image may be captured by a first camera and the second image may be captured by a second camera. In some aspects, the computing device (or one or more components thereof) may include the first camera and the second camera or a device may include the computing device (or one or more components thereof) and the first camera and the second camera. The first camera and the second camera may be a stereoscopic pair. The first image and the second image may be captured at substantially the same time.

At block 708, the computing device (or one or more components thereof) may determine a confidence map based on the predicted disparity map. For example, LDB loss determiner 304 of FIG. 3 or FIG. 5 may determine LDB loss 306 of FIG. 3 or FIG. 5 based on predicted difference map 212. As another example, OA loss determiner 406 of FIG. 4A or FIG. 5 may determine OA loss 408 of FIG. 4A or FIG. 5 based on predicted difference map 212.

At block 710, the computing device (or one or more components thereof) may determine a loss based on the confidence map and a comparison of the predicted disparity map and the ground-truth disparity map. For example, loss determiner 308 of FIG. 3 may determine loss 310 of FIG. 3 based on predicted difference map 212 and LDB loss 306. As another example, loss determiner 410 of FIG. 4A may determine loss 412 of FIG. 4A based on predicted difference map 212 and OA loss 408. As another example, loss determiner 504 of FIG. 5 may determine loss 506 based on predicted difference map 212, LDB loss 306, and OA loss 408.

In some aspects, the confidence map (e.g., determined at block 708) may be a learning-difficulty-balance confidence map. For example, LDB loss 306 may be, or may include, a learning-difficulty-balance confidence map.

In some aspects, the computing device (or one or more components thereof) may determine the confidence map based on a comparison of the predicted disparity map with the ground-truth disparity map. For example, LDB loss determiner 304 may determine LDB loss 306 based on a comparison between predicted difference map 212 and ground-truth difference map 214.

In some aspects, the error (e.g., the loss) is determined based on the confidence map to increase error values (e.g., loss values) for high-confidence pixels and to decrease error values (e.g., loss values) for low-confidence pixels.

In some aspects, a large difference (e.g., a relatively large difference) between a first pixel of the predicted disparity map and a corresponding pixel of the ground-truth disparity map relates to a low value (e.g., a relatively low value) in the confidence map. A small difference (e.g., a relatively small difference) between a second pixel of the predicted disparity map and a corresponding pixel of the ground-truth disparity map relates to a high value (e.g., a relatively high value) in the confidence map.

In some aspects, the computing device (or one or more components thereof) may determine the confidence map (e.g., at block 708) according to:

$${M}_{conf}^{L} ( x ) = {e}^{- {‖ {u}_{gt} ( x ) - u ( x ) ‖}^{2}}$$

where M_{conf}^{L} represents the confidence map;
where x represents a given pixel;
where u_{gt}(x) represents the ground-truth disparity map for the given pixel x; and
where u(x) represents the predicted disparity map for the given pixel x.

In some aspects, the computing device (or one or more components thereof) may determine a loss (e.g., as an example of the error) according to:

$${L}_{total}^{L} = {\sum }_{i = 1}^{N} {γ}^{N - i} {‖ ( 1 + α \cdot {( 1 - {M}_{conf}^{L} )}^{γ} ) \cdot ( {f}_{gt} - {f}_{pred} ) ‖}_{1}$$

where Lₜₒₜₐₗ^{L} represents the loss;
where γ is a hyperparameter; and
where α is a hyperparameter.

In some aspects, the confidence map (e.g., determined at block 708) may be, or may include, an occlusion-based confidence map. For example, OA loss 408 may be, or may include, an occlusion-based confidence map.

In some aspects, the error (e.g., the loss) may be determined based on an inverse of the confidence map to increase error values (e.g., loss values) for low-confidence pixels and to decrease error values (e.g., loss values) for high-confidence pixels.

In some aspects, the computing device (or one or more components thereof) may predict, using the machine-learning model, the first-to-second disparity map between the first image and the second image; flip the first image to generate a flipped first image; flip the second image to generate a flipped second image; and predict, using the machine-learning model, the second-to-first disparity map based on the flipped second image and the flipped first image. For example, difference model 204 of FIG. 4A and FIG. 5 may generate predicted difference map 212 based on image 208 and image 210. Additionally, 204 of FIG. 4A and FIG. 5 may generate predicted difference map 404 based on image 210 and image 208. As another example, difference model 204 may generate the left-to-right disparity map of FIG. 4C based on image 208 and image 210. Further, trainer 402 or trainer 502 may flip image 210 and image 208 (e.g., as illustrated by FIG. 4C) and provide a flipped image 210 and a flipped image 208 to difference model 204. Difference model 204 may generate an intermediate disparity map. Trainer 402 or trainer 502 may flip the intermediate disparity map to generate a right-to-left disparity map as illustrated by FIG. 4C.

In some aspects, the confidence map is determined based on an the first-to-second disparity map and a flipped second-to-first disparity map.

In some aspects, a small difference (e.g., a relatively small difference) between a first disparity of the first-to-second disparity map and an inverse of a corresponding disparity of the second-to-first disparity map relates to a high value (e.g., a relatively high value) in the confidence map. A large difference (e.g., a relatively large) difference between a first disparity of the first-to-second disparity map and an inverse of a corresponding disparity of the second-to-first disparity map relates to a low value (e.g., a relatively low value) in the confidence map.

In some aspects, the computing device (or one or more components thereof) may determine the confidence map based on a first-to-second disparity map between the first image and the second image and a second-to-first disparity map between the second image and the first image. For example, OA loss determiner 406 may determine OA loss 408 based on predicted difference map 212 and predicted difference map 404 of FIG. 4A or FIG. 5.

In some aspects, the computing device (or one or more components thereof) may determine the occlusion-based confidence map according to:

$${M}_{conf}^{D} ( x ) = exp ( - \frac{{\vert {\hat{V}}^{f} ( x ) + {\hat{V}}^{b} ( x + {\hat{V}}^{f} ( x ) ) \vert}^{2}}{{γ}_{1} ( {\vert {\hat{V}}^{f} \vert}^{2} + {\vert {\hat{V}}^{b} ( x + {\hat{V}}^{f} ( x ) ) \vert}^{2} ) + {γ}_{2}} )$$

where M_{conf}^{D}(x) represents a confidence of a given pixel x;
where \hat{V}^{f}(x) represents a forward optical flow vector for the given pixel;
where \hat{V}^{b}(x) represents a backward optical flow vector for the given pixel; and
where γ₁ and γ₂ are hyperparameters.

In some aspects, the computing device (or one or more components thereof) may determine a loss (e.g., as an example of the error) according to:

$${L}_{total}^{D} = {\sum }_{i = 1}^{N} {γ}^{N - i} {‖ ( 1 + α \cdot {( {M}_{c o n f}^{D} )}^{γ} ) \cdot ( {f}_{gt} - {f}_{p r e d} ) ‖}_{1}$$

where Lₜₒₜₐₗ^{D} represents the loss;
where γ is a hyperparameter; and
where α is a hyperparameter.

In some aspects, to determine the confidence map, the one or more processors are configured to: determine a learning-difficulty-balance confidence map based on a comparison of the predicted disparity map with the ground-truth disparity map; and determine an occlusion-based confidence map based on the first image and the second image. The error (e.g., the loss) may be determined based on the learning-difficulty-balance confidence map and the occlusion-based confidence map. For example, LDB loss determiner 304 of FIG. 5 may determine LDB loss 306, OA loss determiner 406 of FIG. 5 may determine OA loss 408, and loss determiner 504 of FIG. 5 may determine loss 506 based on predicted difference map 212, ground-truth difference map 214, LDB loss 306, and OA loss 408.

In some aspects, the computing device (or one or more components thereof) may determine a loss (e.g., as an example of the error) according to:

$${L}_{total} = {\sum }_{i = 1}^{N} {γ}^{N - i} {‖ ( 1 + {α}_{1} \cdot {( 1 - {M}_{c o n f}^{L} )}^{{γ}_{1}} + {α}_{2} \cdot {( {M}_{c o n f}^{D} )}^{{γ}_{2}} ) \cdot ( {f}_{gt} - {f}_{p r e d} ) ‖}_{1}$$

where Lₜₒₜₐₗ represents the loss;
where M_{conf}^{L} represents the first confidence map;
where M_{conf}^{D}(x) represents the occlusion-based confidence map;
where f_{gt} represents the ground-truth disparity map;
where f_{pred} represents the predicted disparity map; and
where α₁, α₂, γ₁, and γ₂ are hyperparameters.

In some aspects, the computing device (or one or more components thereof) may determine a loss (e.g., as an example of the error) according to:

$${L}_{total} = {\sum }_{i = 1}^{N} {γ}^{N - i} {‖ ( 1 + {α}_{2} \cdot {( {M}_{c o n f}^{D} )}^{{γ}_{2}} ( 1 + {α}_{1} \cdot {( 1 - {M}_{c o n f}^{L} )}^{{γ}_{1}} ) ) \cdot ( {f}_{gt} - {f}_{p r e d} ) ‖}_{1}$$

where Lₜₒₜₐₗ represents the loss;
where M_{conf}^{L} represents the first confidence map;
where M_{conf}^{D}(x) represents the occlusion-based confidence map;
where f_{gt} represents the ground-truth disparity map;
where f_{pred} represents the predicted disparity map; and
where α₁, α₂, γ₁, and γ₂ are hyperparameters.

In some aspects, the error (e.g., the loss) may be determined based on an inverse of the learning-difficulty-balance confidence map to increase error values (e.g., loss values) for low-confidence pixels of the learning-difficulty-balance confidence map and to decrease error values (e.g., loss values) for high-confidence pixels of the learning-difficulty-balance confidence map. Additionally or alternatively, the error may be determined based on the occlusion-based confidence map to increase error values for high-confidence pixels of the occlusion-based confidence map and to decrease error values for low-confidence pixels of the occlusion-based confidence map.

At block 712, the computing device (or one or more components thereof) may adjust one or more parameters of the machine-learning model based on the error (e.g., the loss). For example, adjuster 220 of FIG. 3, FIG. 4A, or FIG. 5 may adjust one or more parameters (e.g., weights) of difference model 204 based on loss 310 of FIG. 3, loss 412 of FIG. 4A, or loss 506 of FIG. 5.

In some aspects, the computing device (or one or more components thereof) may adjust the at least one parameter on the apparatus in an online training process.

In some aspects, the computing device (or one or more components thereof) may cause at least one image to be displayed based on an optical-flow prediction from the machine-learning model.

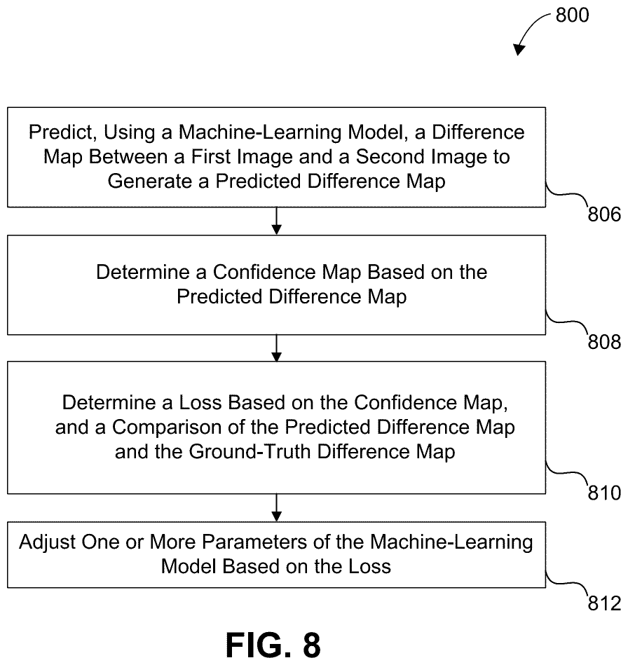

FIG. 8 is a flow diagram illustrating an example process 800 for determining an error (e.g., a loss) and training an optical-flow model based on the error, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors. As an example, process 800 may be implemented by system 300 of FIG. 3, by system 400 or FIG. 4A, and/or by system 500 of FIG. 5.

At block 806, a computing device (or one or more components thereof) may predict, using a machine-learning model, a difference map indicative of differences between a first image and a second image to generate a predicted difference map. For example, trainer 302 of FIG. 3, trainer 402 of FIG. 4A, or trainer 502 of FIG. 5 may obtain image 208 and image 210 of training data 206 of FIG. 3, FIG. 4A, or FIG. 5. Additionally, difference model 204 of FIG. 3, FIG. 4A, or FIG. 5 may predict predicted difference map 212 of FIG. 3, FIG. 4A, or FIG. 5.

In some aspects, the first image may be captured at a first time and the second image may be captured at a second time. The first image and the second image may be captured by a camera (e.g., the same camera). In some aspects, the computing device (or one or more components thereof) may include the camera or a device may include the computing device (or one or more components thereof) and the camera. In such aspects, the difference map may be, or may include, an optical flow.

In some aspects, the first image may be captured from a first position and the second image may be captured from a second position. The first image may be captured by a first camera and the second image may be captured by a second camera. In some aspects, the computing device (or one or more components thereof) may include the first camera and the second camera or a device may include the computing device (or one or more components thereof) and the first camera and the second camera. The first camera and the second camera may be a stereoscopic pair. The first image and the second image may be captured at substantially the same time. In such aspects, the difference map may be, or may include, a disparity map.

At block 808, the computing device (or one or more components thereof) may determine a confidence map based on the predicted difference map. For example, LDB loss determiner 304 of FIG. 3 or FIG. 5 may determine LDB loss 306 of FIG. 3 or FIG. 5 based on predicted difference map 212. As another example, OA loss determiner 406 of FIG. 4A or FIG. 5 may determine OA loss 408 of FIG. 4A or FIG. 5 based on predicted difference map 212.

At block 810, the computing device (or one or more components thereof) may determine a loss based on the confidence map and a comparison of the predicted difference map and the ground-truth difference map. For example, loss determiner 308 of FIG. 3 may determine loss 310 of FIG. 3 based on predicted difference map 212 and LDB loss 306. As another example, loss determiner 410 of FIG. 4A may determine loss 412 of FIG. 4A based on predicted difference map 212 and OA loss 408. As another example, loss determiner 504 of FIG. 5 may determine loss 506 based on predicted difference map 212, LDB loss 306, and OA loss 408.

In some aspects, the confidence map (e.g., determined at block 808) may be a learning-difficulty-balance confidence map. For example, LDB loss 306 may be, or may include, a learning-difficulty-balance confidence map.

In some aspects, the confidence map (e.g., determined at block 808) may be, or may include, an occlusion-based confidence map. For example, OA loss 408 may be, or may include, an occlusion-based confidence map.

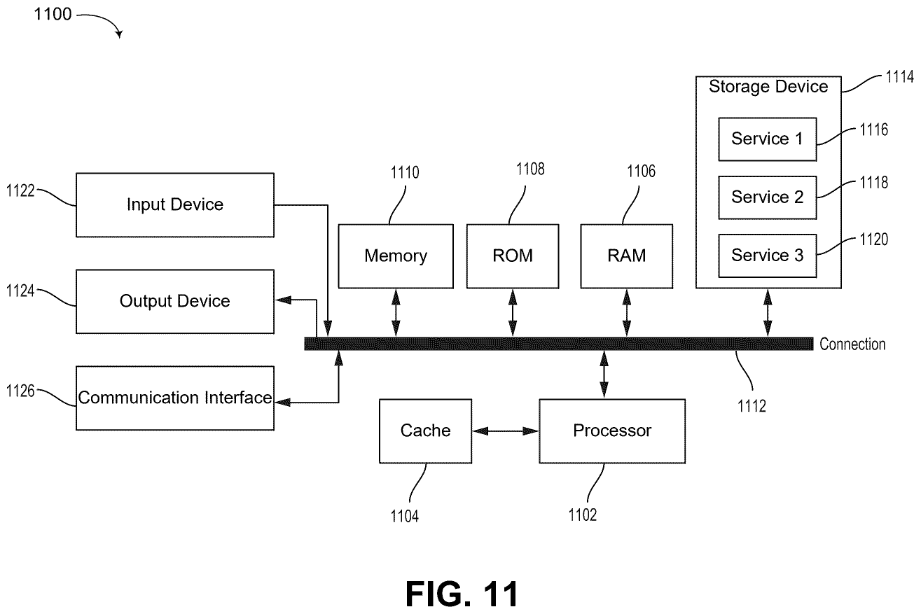

At block 812, the computing device (or one or more components thereof) may adjust one or more parameters of the machine-learning model based on the error. For example, adjuster 220 of FIG. 3, FIG. 4A, or FIG. 5 may adjust one or more parameters (e.g., weights) of difference model 204 based on loss 310 of FIG. 3, loss 412 of FIG. 4A, or loss 506 of FIG. 5. In some examples, as noted previously, the methods described herein (e.g., process 600 of FIG. 6, process 700 of FIG. 7, process 800 of FIG. 8, and/or other methods described herein) can be performed, in whole or in part, by a computing device or apparatus. In one example, one or more of the methods can be performed by system 200 of FIG. 2, system 300 of FIG. 3, system 400, of FIG. 4A, system 500 of FIG. 5, or by another system or device. In another example, one or more of the methods (e.g., process 600 of FIG. 6, process 700 of FIG. 7, process 800 of FIG. 8, and/or other methods described herein) can be performed, in whole or in part, by the computing-device architecture 1100 shown in FIG. 11. For instance, a computing device with the computing-device architecture 1100 shown in FIG. 11 can include, or be included in, the components of the system 200, system 300, system 400, and/or system 500 and can implement the operations of process 600, process 700, process 800, and/or other process described herein.

In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 600, the process 700, and the process 800 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600, the process 700, the process 800, and/or other processes described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

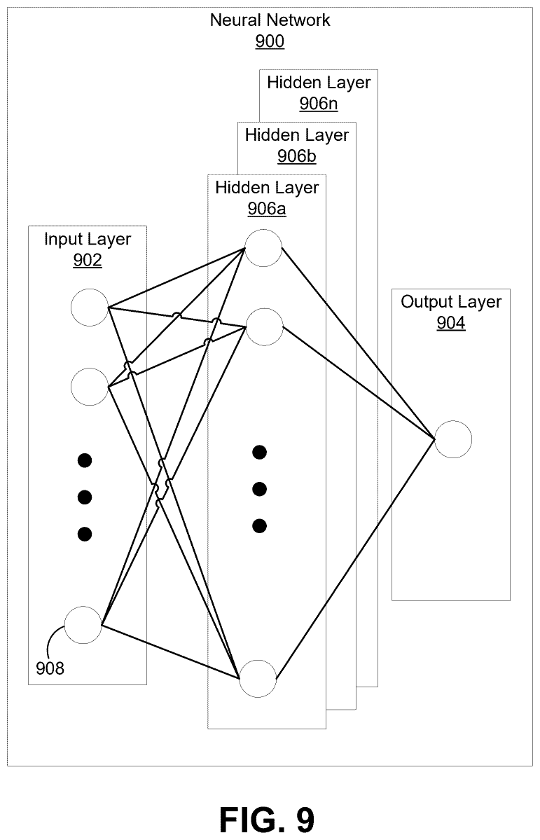

FIG. 9 is an illustrative example of a neural network 900 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 900 may be an example of, or can implement, difference model 204 of FIG. 2, FIG. 3, FIG. 4A, and/or FIG. 5.

An input layer 902 includes input data. In one illustrative example, input layer 902 can include data representing image 208 and image 210 of FIG. 2, FIG. 3, FIG. 4A, and/or FIG. 5. Neural network 900 includes multiple hidden layers, for example, hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n. In one illustrative example, output layer 904 can provide predicted difference map 212 and/or predicted difference map 404 of FIG. 2, FIG. 3, FIG. 4A, and/or FIG. 5.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, an error function (e.g., a loss function), a backward pass, and a weight update. The forward pass, error function (e.g., the loss function), backward pass, and parameter update are performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function (or error function) can be used to analyze loss or error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

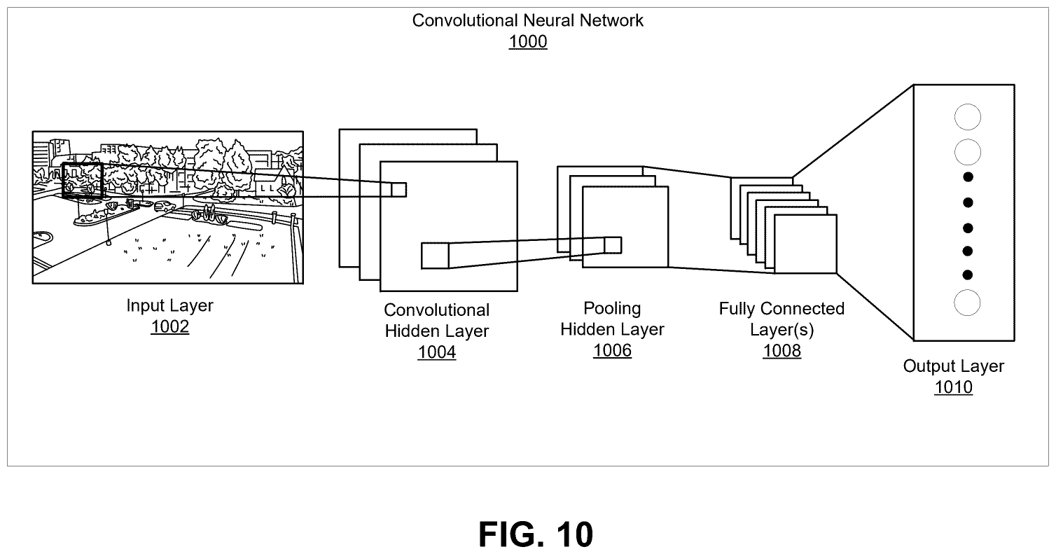

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

In some aspects, training of one or more of the machine learning systems or neural networks described herein (e.g., such as the optical flow estimation network of FIG. 1A, the trainer 202 of FIG. 2, the trainer 302 of FIG. 3, the trainer 402 of FIG. 4A, the trainer 502 of FIG. 5, the neural network 900 of FIG. 9, the CNN 1000 of FIG. 10, among various other machine learning networks described herein) can be performed using online training (e.g., in some case on-device training), offline training, and/or various combinations of online and offline training. In some cases, online may refer to time periods during which the input data (e.g., such as the input data of FIG. 1A, the training data 206 of FIG. 2, etc.) is processed, for instance for performance of the optical flow techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of system 200 of FIG. 2, system 300 of FIG. 3, system 400, of FIG. 4A, system 500 of FIG. 5 and/or other devices, modules, or systems described herein. Additionally or alternatively, computing-device architecture 1100 may be configured to perform process 600 of FIG. 6, process 700 of FIG. 7, process 800 of FIG. 8, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, the apparatus comprising: one or more memories configured to store the image data; and one or more processors coupled to the one or more memories and configured to: obtain a first image captured at a first time; obtain a second image captured at a second time; predict, using a machine-learning model, an optical flow between the first image and the second image to generate a predicted optical flow; determine a confidence map based on the predicted optical flow; determine an error based on the confidence map and a comparison of the predicted optical flow and a ground-truth optical flow; and adjust one or more parameters of the machine-learning model based on the error.

Aspect 2. The apparatus of aspect 1, wherein the one or more processors are configured to determine the confidence map based on a comparison of the predicted optical flow with the ground-truth optical flow.

Aspect 3. The apparatus of aspect 2, wherein the one or more processors are configured to determine the confidence map according to:

$${M}_{c o n f}^{L} ( x ) = {e}^{- {‖ {u}_{g t} ( x ) - u ( x ) ‖}^{2}}$$

where M_{conf}^{L} represents the confidence map;
where x represents a given pixel;
where u_{gt}(x) represents the ground-truth optical flow for the given pixel x; and
where u(x) represents the predicted optical flow for the given pixel x.

Aspect 4. The apparatus of aspect 3, wherein the one or more processors are configured to determine the error according to:

$${L}_{total}^{L} = {\sum }_{i = 1}^{N} {γ}^{N - i} {‖ ( 1 + α \cdot {( 1 - {M}_{c o n f}^{L} )}^{γ} ) \cdot ( {f}_{gt} - {f}_{p r e d} ) ‖}_{1}$$

where Lₜₒₜₐₗ^{L} represents the error;
where γ is a hyperparameter; and
where α is a hyperparameter.

Aspect 5. The apparatus of any one of aspects 1 to 4, wherein the confidence map is an occlusion-based confidence map.

Aspect 6. The apparatus of aspect 5, wherein the one or more processors are configured to determine the occlusion-based confidence map based on a forward optical flow between the first image and the second image and backward optical flow between the second image and the first image.

Aspect 7. The apparatus of any one of aspects 5 or 6, wherein the one or more processors are configured to determine the occlusion-based confidence map according to:

$${M}_{c o n f}^{D} ( x ) = exp ( - \frac{{\vert {\hat{V}}^{f} ( x ) + {\hat{V}}^{b} ( x + {\hat{V}}^{f} ( x ) ) \vert}^{2}}{{γ}_{1} ( {\vert {\hat{V}}^{f} \vert}^{2} + {\vert {\hat{V}}^{b} ( x + {\hat{V}}^{f} ( x ) ) \vert}^{2} ) + {γ}_{2}} )$$

where M_{conf}^{D}(x) represents a confidence of a given pixel x;
where \hat{V}^{f}(x) represents a forward optical flow vector for the given pixel x;
where \hat{V}^{b}(x) represents a backward optical flow vector for the given pixel x; and
where γ₁ and γ₂ are hyperparameters.

Aspect 8. The apparatus of aspect 7, wherein the one or more processors are configured to determine the error according to:

$${L}_{total}^{D} = {\sum }_{i = 1}^{N} {γ}^{N - i} {‖ ( 1 + α \cdot {( {M}_{c o n f}^{D} )}^{γ} ) \cdot ( {f}_{gt} - {f}_{p r e d} ) ‖}_{1}$$

where Lₜₒₜₐₗ^{D} represents the error;
where γ is a hyperparameter; and
where α is a hyperparameter.

Aspect 9. The apparatus of any one of aspects 1 to 8, wherein, to determine the confidence map, the one or more processors are configured to: determine a first confidence map based on a comparison of the predicted optical flow with the ground-truth optical flow; and determine an occlusion-based confidence map based on the first image and the second image; wherein the error is determined based on the first confidence map and the occlusion-based confidence map.

Aspect 10. The apparatus of aspect 9, wherein the one or more processors are configured to determine the error according to:

$${L}_{total} = {\sum }_{i = 1}^{N} {γ}^{N - i} {‖ ( 1 + {α}_{1} \cdot {( 1 - {M}_{c o n f}^{L} )}^{{γ}_{1}} + {α}_{2} \cdot {( {M}_{c o n f}^{D} )}^{{γ}_{2}} ) \cdot ( {f}_{gt} - {f}_{p r e d} ) ‖}_{1}$$

where Lₜₒₜₐₗ represents the error;
where M_{conf}^{L} represents the first confidence map;
where M_{conf}^{D}(x) represents the occlusion-based confidence map;
where f_{gt} represents the ground-truth optical flow;
where f_{pred} represents the predicted optical flow; and
where α₁, α₂, γ₁, and γ₂ are hyperparameters.

Aspect 11. The apparatus of aspect 9, wherein the one or more processors are configured to determine the error according to:

$${L}_{total} = {\sum }_{i = 1}^{N} {γ}^{N - i} {‖ ( 1 + {α}_{2} \cdot {( {M}_{c o n f}^{D} )}^{{γ}_{2}} ( 1 + {α}_{1} \cdot {( 1 - {M}_{c o n f}^{L} )}^{{γ}_{1}} ) ) \cdot ( {f}_{gt} - {f}_{p r e d} ) ‖}_{1}$$

where Lₜₒₜₐₗ represents the error;
where M_{conf}^{L} represents the first confidence map;
where M_{conf}^{D}(x) represents the occlusion-based confidence map;
where f_{gt} represents the ground-truth optical flow;
where f_{pred} represents the predicted optical flow; and
where α₁, α₂, γ₁, and γ₂ are hyperparameters.

Aspect 12. The apparatus of any one of Aspects 1 to 11, wherein the one or more processors are configured to adjust the one or more parameters on the apparatus as an online training process.

Aspect 13. The apparatus of any one of Aspects 1 to 12, further comprising at least one camera configured to capture the image data.

Aspect 14. The apparatus of any one of Aspects 1 to 13, further comprising at least one display configured to display at least one image based on an optical flow prediction from the machine-learning model.

Aspect 15. An apparatus for processing image data, the apparatus comprising: one or more memories configured to store the image data; and one or more processors coupled to the one or more memories and configured to: obtain a first image captured at a first time; obtain a second image captured at a second time; predict, using a machine-learning model, an optical flow between the first image and the second image to generate a predicted optical flow; determine an occlusion-based confidence map based on first image and the second image; determine an error based on the occlusion-based confidence map and a comparison of the predicted optical flow and a ground-truth optical flow; and adjust one or more parameters of the machine-learning model based on the error.

Aspect 16. An apparatus for processing image data, the apparatus comprising: one or more memories configured to store the image data; and one or more processors coupled to the one or more memories and configured to: obtain a first image captured at a first time; obtain a second image captured at a second time; predict, using a machine-learning model, an optical flow between the first image and the second image to generate a predicted optical flow; determine a confidence map based on the predicted optical flow and a ground-truth optical flow; determine an occlusion-based confidence map based on first image and the second image; determine an error based on the confidence map, the occlusion-based confidence map, and a comparison of the predicted optical flow and the ground-truth optical flow; and adjust one or more parameters of the machine-learning model based on the error.

Aspect 17. A method for processing image data, the method comprising: obtaining a first image captured at a first time; obtaining a second image captured at a second time; predicting, using a machine-learning model, an optical flow between the first image and the second image to generate a predicted optical flow; determining a confidence map based on the predicted optical flow; determining an error based on the confidence map and a comparison of the predicted optical flow and a ground-truth optical flow; and adjusting one or more parameters of the machine-learning model based on the error.

Aspect 18. The method of aspect 17, further comprising determine the confidence map based on a comparison of the predicted optical flow with the ground-truth optical flow.

Aspect 19. The method of aspect 18, further comprising determining the confidence map according to:

$${M}_{c o n f}^{L} ( x ) = {e}^{- {‖ {u}_{g t} ( x ) - u ( x ) ‖}^{2}}$$

where M_{conf}^{L} represents the confidence map;
where x represents a given pixel;
where u_{gt}(x) represents the ground-truth optical flow for the given pixel x; and
where u(x) represents the predicted optical flow for the given pixel x.

Aspect 20. The method of aspect 19, further comprising determining the error according to:

$${L}_{total}^{L} = {\sum }_{i = 1}^{N} {γ}^{N - i} {‖ ( 1 + α \cdot {( 1 - {M}_{c o n f}^{L} )}^{γ} ) \cdot ( {f}_{gt} - {f}_{p r e d} ) ‖}_{1}$$

where Lₜₒₜₐₗ^{L} represents the error;
where γ is a hyperparameter; and
where α is a hyperparameter.

Aspect 21. The method of any one of aspects 17 to 20, wherein the confidence map is an occlusion-based confidence map.

Aspect 22. The method of aspect 21, further comprising determining the occlusion-based confidence map based on a forward optical flow between the first image and the second image and backward optical flow between the second image and the first image.

Aspect 23. The method of any one of aspects 21 or 22, further comprising determining the occlusion-based confidence map according to:

$${M}_{c o n f}^{D} ( x ) = exp ( - \frac{{\vert {\hat{V}}^{f} ( x ) + {\hat{V}}^{b} ( x + {\hat{V}}^{f} ( x ) ) \vert}^{2}}{{γ}_{1} ( {\vert {\hat{V}}^{f} \vert}^{2} + {\vert {\hat{V}}^{b} ( x + {\hat{V}}^{f} ( x ) ) \vert}^{2} ) + {γ}_{2}} )$$

where M_{conf}^{D}(x) represents a confidence of a given pixel x;
where \hat{V}^{f}(x) represents a forward optical flow vector for the given pixel x;
where \hat{V}^{b}(x) represents a backward optical flow vector for the given pixel x; and
where γ₁ and γ₂ are hyperparameters.

Aspect 24. The method of aspect 23, further comprising determining the error according to:

$${L}_{total}^{D} = {\sum }_{i = 1}^{N} {γ}^{N - i} {‖ ( 1 + α \cdot {( {M}_{c o n f}^{D} )}^{γ} ) \cdot ( {f}_{gt} - {f}_{p r e d} ) ‖}_{1}$$

where Lₜₒₜₐₗ^{D} represents the error;
where γ is a hyperparameter; and
where α is a hyperparameter.

Aspect 25. The method of any one of aspects 17 to 24, wherein determining the confidence map comprises determining a first confidence map based on a comparison of the predicted optical flow with the ground-truth optical flow; and determining an occlusion-based confidence map based on the first image and the second image; wherein the error is determined based on the first confidence map and the occlusion-based confidence map.

Aspect 26. The method of aspect 25, further comprising determining the error according to:

$${L}_{total} = {\sum }_{i = 1}^{N} {γ}^{N - i} {‖ ( 1 + {α}_{1} \cdot {( 1 - {M}_{c o n f}^{L} )}^{{γ}_{1}} + {α}_{2} \cdot {( {M}_{c o n f}^{D} )}^{{γ}_{2}} ) \cdot ( {f}_{gt} - {f}_{p r e d} ) ‖}_{1}$$

where Lₜₒₜₐₗ represents the error;
where M_{conf}^{L} represents the first confidence map;
where M_{conf}^{D}(x) represents the occlusion-based confidence map;
where f_{gt} represents the ground-truth optical flow;
where f_{pred} represents the predicted optical flow; and
where α₁, α₂, γ₁, and γ₂ are hyperparameters.

Aspect 27. The method of aspect 25, further comprising determining the error according to:

$${L}_{total} = {\sum }_{i = 1}^{N} {γ}^{N - i} {‖ ( 1 + {α}_{2} \cdot {( {M}_{c o n f}^{D} )}^{{γ}_{2}} ( 1 + {α}_{1} \cdot {( 1 - {M}_{c o n f}^{L} )}^{{γ}_{1}} ) ) \cdot ( {f}_{gt} - {f}_{p r e d} ) ‖}_{1}$$

where Lₜₒₜₐₗ represents the error;
where M_{conf}^{L} represents the first confidence map;
where M_{conf}^{D}(x) represents the occlusion-based confidence map;
where f_{gt} represents the ground-truth optical flow;
where f_{pred} represents the predicted optical flow; and
where α₁, α₂, γ₁, and γ₂ are hyperparameters.

Aspect 28. The method of any one of Aspects 17 to 27, further comprising adjusting the one or more parameters as an online training process

Aspect 29. An method for processing image data, the method comprising obtaining a first image captured at a first time; obtaining a second image captured at a second time; predicting, using a machine-learning model, an optical flow between the first image and the second image to generate a predicted optical flow; determining an occlusion-based confidence map based on first image and the second image; determining an error based on the occlusion-based confidence map and a comparison of the predicted optical flow and a ground-truth optical flow; and adjusting one or more parameters of the machine-learning model based on the error.

Aspect 30. An method for processing image data, the method comprising: obtaining a first image captured at a first time; obtaining a second image captured at a second time; predicting, using a machine-learning model, an optical flow between the first image and the second image to generate a predicted optical flow; determining a confidence map based on the predicted optical flow and a ground-truth optical flow; determining an occlusion-based confidence map based on first image and the second image; determining an error based on the confidence map, the occlusion-based confidence map, and a comparison of the predicted optical flow and the ground-truth optical flow; and adjusting one or more parameters of the machine-learning model based on the error.

Aspect 31. A non-transitory computer-readable storage medium having stored thereon instructions that, when executed by one or more processors, cause the one or more processors to perform operations according to any of aspects 17 to 30.

Aspect 32. An apparatus for providing virtual content for display, the apparatus comprising one or more means for perform operations according to any of aspects 17 to 30.

Aspect 33. An apparatus for processing image data, the apparatus comprising: one or more memories; and one or more processors coupled to the one or more memories and configured to: predict, using a machine-learning model, an optical flow between a first image and a second image to generate a predicted optical flow, wherein the first image is captured at a first time and wherein the second image is captured at a second time; determine a confidence map based on the predicted optical flow; determine an error based on the confidence map and a comparison of the predicted optical flow and a ground-truth optical flow; and adjust at least one parameter of the machine-learning model based on the error.

Aspect 34. The apparatus of aspect 33, wherein the confidence map is a learning-difficulty-balance confidence map.

Aspect 35. The apparatus of any one of aspects 33 of 34, wherein the one or more processors are configured to determine the confidence map based on a comparison of the predicted optical flow with the ground-truth optical flow.

Aspect 36. The apparatus of aspect 35, wherein: a large difference between a first pixel of the predicted optical flow and a corresponding pixel of the ground-truth optical flow relates to a low value in the confidence map; and a small difference between a second pixel of the predicted optical flow and a corresponding pixel of the ground-truth optical flow relates to a high value in the confidence map.

Aspect 37. The apparatus of any one of aspects 33 to 36, wherein the error is determined based on an inverse of the confidence map to increase error values for low-confidence pixels and to decrease error values for high-confidence pixels.

Aspect 38. The apparatus of any one of aspects 33 to 37, wherein the confidence map is an occlusion-based confidence map.

Aspect 39. The apparatus of any one of aspects 33 to 38, wherein the one or more processors are configured to determine the confidence map based on a forward optical flow between the first image and the second image and backward optical flow between the second image and the first image.

Aspect 40. The apparatus of aspect 39, wherein the one or more processors are configured to: predict, using the machine-learning model, the forward optical flow between the first image and the second image; and predict, using the machine-learning model, the backward optical flow between the second image and the first image.

Aspect 41. The apparatus of any one of aspects 39 or 40, wherein: a small difference between a first forward vector between the first image and the second image and an inverse of a first backward vector between the second image and the first image relates to a high value in the confidence map; and a large difference between a second forward vector between the first image and the second image and the inverse of a second backward vector between the second image and the first image relates to a low value in the confidence map.

Aspect 42. The apparatus of any one of aspects 33 to 41, wherein the error is determined based on the confidence map to increase error values for high-confidence pixels and to decrease error values for low-confidence pixels.

Aspect 43. The apparatus of any one of aspects 33 to 42, wherein, to determine the confidence map, the one or more processors are configured to: determine a learning-difficulty-balance confidence map based on a comparison of the predicted optical flow with the ground-truth optical flow; and determine an occlusion-based confidence map based on the first image and the second image; wherein the error is determined based on the learning-difficulty-balance confidence map and the occlusion-based confidence map.

Aspect 44. The apparatus of aspect 43, wherein: the error is determined based on an inverse of the learning-difficulty-balance confidence map to increase error values for low-confidence pixels of the learning-difficulty-balance confidence map and to decrease error values for high-confidence pixels of the learning-difficulty-balance confidence map; and the error is determined based on the occlusion-based confidence map to increase error values for high-confidence pixels of the occlusion-based confidence map and to decrease error values for low-confidence pixels of the occlusion-based confidence map.

Aspect 45. The apparatus of any one of aspects 33 to 44, wherein the first image and the second image are captured by a camera.

Aspect 46. The apparatus of aspect 45, further comprising the camera.

Aspect 47. The apparatus of any one of aspects 33 to 46, wherein the one or more processors are configured to adjust the at least one parameter on the apparatus in an online training process.

Aspect 48. The apparatus of any one of aspects 33 to 47, wherein the one or more processors are configured to provide at least one image based on an optical-flow prediction from the machine-learning model to a display to be displayed.

Aspect 49. A method for processing image data, the method comprising: predicting, using a machine-learning model, an optical flow between a first image and a second image to generate a predicted optical flow, wherein the first image is captured at a first time and wherein the second image is captured at a second time; determining a confidence map based on the predicted optical flow; determining an error based on the confidence map and a comparison of the predicted optical flow and a ground-truth optical flow; and adjusting at least one parameter of the machine-learning model based on the error.

Aspect 50. The method of aspect 49, wherein the confidence map is a learning-difficulty-balance confidence map.

Aspect 51. The method of any one of aspects 49 or 50, further comprising determining the confidence map based on a comparison of the predicted optical flow with the ground-truth optical flow.

Aspect 52. The method of aspect 51, wherein: a large difference between a first pixel of the predicted optical flow and a corresponding pixel of the ground-truth optical flow relates to a low value in the confidence map; and a small difference between a second pixel of the predicted optical flow and a corresponding pixel of the ground-truth optical flow relates to a high value in the confidence map.

Aspect 53. The method of any one of aspects 49 to 52, wherein the error is determined based on an inverse of the confidence map to increase error values for low-confidence pixels and to decrease error values for high-confidence pixels.

Aspect 54. The method of aspect 49, wherein the confidence map is an occlusion-based confidence map.

Aspect 55. The method of any one of aspects 49 to 54, further comprising determining the confidence map based on a forward optical flow between the first image and the second image and backward optical flow between the second image and the first image.

Aspect 56. The method of aspect 55, further comprising: predicting, using the machine-learning model, the forward optical flow between the first image and the second image; and predicting, using the machine-learning model, the backward optical flow between the second image and the first image.

Aspect 57. The method of any one of aspects 55 or 56, wherein: a small difference between a first forward vector between the first image and the second image and an inverse of a first backward vector between the second image and the first image relates to a high value in the confidence map; and a large difference between a second forward vector between the first image and the second image and the inverse of a second backward vector between the second image and the first image relates to a low value in the confidence map.

Aspect 58. The method of any one of aspects 49 to 57, wherein the error is determined based on the confidence map to increase error values for high-confidence pixels and to decrease error values for low-confidence pixels.

Aspect 59. The method of any one of aspects 49 to 58, wherein determining the confidence map comprises: determining a learning-difficulty-balance confidence map based on a comparison of the predicted optical flow with the ground-truth optical flow; and determining an occlusion-based confidence map based on the first image and the second image; wherein the error is determined based on the learning-difficulty-balance confidence map and the occlusion-based confidence map.

Aspect 60. The method of aspect 59, wherein: the error is determined based on an inverse of the learning-difficulty-balance confidence map to increase error values for low-confidence pixels of the learning-difficulty-balance confidence map and to decrease error values for high-confidence pixels of the learning-difficulty-balance confidence map; and the error is determined based on the occlusion-based confidence map to increase error values for high-confidence pixels of the occlusion-based confidence map and to decrease error values for low-confidence pixels of the occlusion-based confidence map.

Aspect 61. The method of any one of aspects 49 to 60, wherein the first image and the second image are captured by a camera.

Aspect 62. The method of any one of aspects 49 to 61, further comprising adjusting the at least one parameter in an online training process.

Aspect 63. The method of any one of aspects 49 to 62, displaying at least one image based on an optical-flow prediction from the machine-learning model.

Aspect 64. An apparatus for processing image data, the apparatus comprising: one or more memories; and one or more processors coupled to the one or more memories and configured to: predict, using a machine-learning model, a disparity map between a first image and a second image to generate a predicted disparity map, wherein the first image is captured from a first position and wherein the second image is captured from a second position; determine a confidence map based on the predicted disparity map; determine an error based on the confidence map and a comparison of the predicted disparity map and a ground-truth disparity map; and adjust at least one parameter of the machine-learning model based on the error.

Aspect 65. The apparatus of aspect 64, wherein the confidence map is a learning-difficulty-balance confidence map.

Aspect 66. The apparatus of any one of aspects 64 or 65, wherein the one or more processors are configured to determine the confidence map based on a comparison of the predicted disparity map with the ground-truth disparity map.

Aspect 67. The apparatus of aspect 66, wherein: a large difference between a first pixel of the predicted disparity map and a corresponding pixel of the ground-truth disparity map relates to a low value in the confidence map; and a small difference between a second pixel of the predicted disparity map and a corresponding pixel of the ground-truth disparity map relates to a high value in the confidence map.

Aspect 68. The apparatus of any one of aspects 64 to 67, wherein the error is determined based on an inverse of the confidence map to increase error values for low-confidence pixels and to decrease error values for high-confidence pixels.

Aspect 69. The apparatus of any one of aspects 64 to 68, wherein the confidence map is an occlusion-based confidence map.

Aspect 70. The apparatus of any one of aspects 64 to 69, wherein the one or more processors are configured to determine the confidence map based on a first-to-second disparity map between the first image and the second image and a second-to-first disparity map between the second image and the first image.

Aspect 71. The apparatus of aspect 70, wherein the one or more processors are configured to: predict, using the machine-learning model, the first-to-second disparity map between the first image and the second image; flip the first image to generate a flipped first image; flip the second image to generate a flipped second image; and predict, using the machine-learning model, the second-to-first disparity map based on the flipped second image and the flipped first image.

Aspect 72. The apparatus of aspect 71, wherein the confidence map is determined based on an the first-to-second disparity map and a flipped second-to-first disparity map.

Aspect 73. The apparatus of any one of aspects 70 to 72, wherein: a small difference between a first disparity of the first-to-second disparity map and an inverse of a corresponding disparity of the second-to-first disparity map relates to a high value in the confidence map; and a large difference between a first disparity of the first-to-second disparity map and an inverse of a corresponding disparity of the second-to-first disparity map relates to a low value in the confidence map.

Aspect 74. The apparatus of any one of aspects 64 to 73, wherein the error is determined based on the confidence map to increase error values for high-confidence pixels and to decrease error values for low-confidence pixels.

Aspect 75. The apparatus of any one of aspects 64 to 74, wherein, to determine the confidence map, the one or more processors are configured to: determine a learning-difficulty-balance confidence map based on a comparison of the predicted disparity map with the ground-truth disparity map; and determine an occlusion-based confidence map based on the first image and the second image; wherein the error is determined based on the learning-difficulty-balance confidence map and the occlusion-based confidence map.

Aspect 76. The apparatus of aspect 75, wherein: the error is determined based on an inverse of the learning-difficulty-balance confidence map to increase error values for low-confidence pixels of the learning-difficulty-balance confidence map and to decrease error values for high-confidence pixels of the learning-difficulty-balance confidence map; and the error is determined based on the occlusion-based confidence map to increase error values for high-confidence pixels of the occlusion-based confidence map and to decrease error values for low-confidence pixels of the occlusion-based confidence map.

Aspect 77. The apparatus of any one of aspects 64 to 76, wherein the first image is captured by a first camera and wherein the second image is captured by a second camera.

Aspect 78. The apparatus of aspect 77, further comprising the first camera and the second camera.

Aspect 79. The apparatus of any one of aspects 64 to 78, wherein the one or more processors are configured to adjust the at least one parameter on the apparatus in an online training process.

Aspect 80. The apparatus of any one of aspects 64 to 79, wherein the one or more processors are configured to provide at least one image based on a disparity-map prediction from the machine-learning model to a display to be displayed.

Aspect 81. A method for processing image data, the method comprising: predicting, using a machine-learning model, a disparity map between a first image and a second image to generate a predicted disparity map, wherein the first image is captured from a first position and wherein the second image is captured from a second position; determining a confidence map based on the predicted disparity map; determining an error based on the confidence map and a comparison of the predicted disparity map and a ground-truth disparity map; and adjusting at least one parameter of the machine-learning model based on the error.

Aspect 82. The method of aspect 81, wherein the confidence map is a learning-difficulty-balance confidence map.

Aspect 83. The method of any one of aspects 81 or 82, further comprising determining the confidence map based on a comparison of the predicted disparity map with the ground-truth disparity map.

Aspect 84. The method of aspect 83, wherein: a large difference between a first pixel of the predicted disparity map and a corresponding pixel of the ground-truth disparity map relates to a low value in the confidence map; and a small difference between a second pixel of the predicted disparity map and a corresponding pixel of the ground-truth disparity map relates to a high value in the confidence map.

Aspect 85. The method of any one of aspects 81 to 84, wherein the error is determined based on an inverse of the confidence map to increase error values for low-confidence pixels and to decrease error values for high-confidence pixels.

Aspect 86. The method of any one of aspects 81 to 58, wherein the confidence map is an occlusion-based confidence map.

Aspect 87. The method of any one of aspects 81 to 86, further comprising determining the confidence map based on a first-to-second disparity map between the first image and the second image and a second-to-first disparity map between the second image and the first image.

Aspect 88. The method of aspect 87, further comprising: predicting, using the machine-learning model, the first-to-second disparity map between the first image and the second image; flipping the first image to generate a flipped first image; flipping the second image to generate a flipped second image; and predicting, using the machine-learning model, the second-to-first disparity map based on the flipped second image and the flipped first image.

Aspect 89. The method of aspect 88, wherein the confidence map is determined based on an the first-to-second disparity map and a flipped second-to-first disparity map.

Aspect 90. The method of any one of aspects 87 to 89, wherein: a small difference between a first disparity of the first-to-second disparity map and an inverse of a corresponding disparity of the second-to-first disparity map relates to a high value in the confidence map; and a large difference between a first disparity of the first-to-second disparity map and an inverse of a corresponding disparity of the second-to-first disparity map relates to a low value in the confidence map.

Aspect 91. The method of any one of aspects 81 to 90, wherein the error is determined based on the confidence map to increase error values for high-confidence pixels and to decrease error values for low-confidence pixels.

Aspect 92. The method of any one of aspects 81 to 91, wherein determining the confidence map comprises: determining a learning-difficulty-balance confidence map based on a comparison of the predicted disparity map with the ground-truth disparity map; and determining an occlusion-based confidence map based on the first image and the second image; wherein the error is determined based on the learning-difficulty-balance confidence map and the occlusion-based confidence map.

Aspect 93. The method of aspect 92, wherein: the error is determined based on an inverse of the learning-difficulty-balance confidence map to increase error values for low-confidence pixels of the learning-difficulty-balance confidence map and to decrease error values for high-confidence pixels of the learning-difficulty-balance confidence map; and the error is determined based on the occlusion-based confidence map to increase error values for high-confidence pixels of the occlusion-based confidence map and to decrease error values for low-confidence pixels of the occlusion-based confidence map.

Aspect 94. The method of any one of aspects 81 to 93, wherein the first image is captured by a first camera and wherein the second image is captured by a second camera.

Aspect 95. The method of any one of aspects 81 to 94, further comprising adjusting the at least one parameter in an online training process.

Aspect 96. The method of any one of aspects 81 to 95, further comprising displaying at least one image based on a disparity-map prediction from the machine-learning model.

Aspect 97. An apparatus for processing image data, the apparatus comprising: one or more memories configured to store the image data; and one or more processors coupled to the one or more memories and configured to: predict, using a machine-learning model, a difference map indicative of differences between a first image and a second image to generate a predicted difference map; determine a confidence map based on the predicted difference map; determine an error based on the confidence map and a comparison of the predicted difference map and a ground-truth difference map; and adjust one or more parameters of the machine-learning model based on the error.

Aspect 98. The apparatus of claim 97, wherein: the first image is captured at a first time; the second image is captured at a second time; the predicted difference map comprises a predicted optical flow; the machine-learning model is trained to predict optical flows based on images captured at different times; and the ground-truth difference map is a ground-truth optical flow.

Aspect 99. The apparatus of claim 97, wherein: the first image is captured from a first position; the second image is captured from a second position; the predicted difference map comprises a predicted disparity map; the machine-learning model is trained to predict disparity maps based on images captured from different positions; and the ground-truth difference map is a ground-truth disparity map.

Aspect 100. A method for processing image data, the method comprising: predicting, using a machine-learning model, a difference map indicative of differences between a first image and a second image to generate a predicted difference map; determining a confidence map based on the predicted difference map; determining an error based on the confidence map and a comparison of the predicted difference map and a ground-truth difference map; and adjusting one or more parameters of the machine-learning model based on the error.

Aspect 101. The method of aspect 100, wherein: the first image is captured at a first time; the second image is captured at a second time; the predicted difference map comprises a predicted optical flow; the machine-learning model is trained to predict optical flows based on images captured at different times; and the ground-truth difference map is a ground-truth optical flow.

Aspect 102 The method of aspect 100, wherein: the first image is captured from a first position; the second image is captured from a second position; the predicted difference map comprises a predicted disparity map; the machine-learning model is trained to predict disparity maps based on images captured from different positions; and the ground-truth difference map is a ground-truth disparity map.

Aspect 103. A non-transitory computer-readable storage medium having stored thereon instructions that, when executed by one or more processors, cause the one or more processors to perform operations according to any of aspects 49 to 63, 81 to 96, or 100 to 102.

Aspect 104. An apparatus for providing virtual content for display, the apparatus comprising one or more means for perform operations according to any of aspects 49 to 63, 81 to 96, or 100 to 102.

What is claimed is:

1. An apparatus for processing image data, the apparatus comprising:
one or more memories; and
one or more processors coupled to the one or more memories and configured to:
predict, using a machine-learning model, a disparity map between a first image and a second image to generate a predicted disparity map, wherein the first image is captured from a first position and wherein the second image is captured from a second position;
determine a confidence map based on the predicted disparity map;
determine an error based on the confidence map and a comparison of the predicted disparity map and a ground-truth disparity map; and
adjust at least one parameter of the machine-learning model based on the error.

2. The apparatus of claim 1, wherein the confidence map is a learning-difficulty-balance confidence map.

3. The apparatus of claim 1, wherein the one or more processors are configured to determine the confidence map based on a comparison of the predicted disparity map with the ground-truth disparity map.

4. The apparatus of claim 3, wherein:
a large difference between a first pixel of the predicted disparity map and a corresponding pixel of the ground-truth disparity map relates to a low value in the confidence map; and
a small difference between a second pixel of the predicted disparity map and a corresponding pixel of the ground-truth disparity map relates to a high value in the confidence map.

5. The apparatus of claim 1, wherein the error is determined based on an inverse of the confidence map to increase error values for low-confidence pixels and to decrease error values for high-confidence pixels.

6. The apparatus of claim 1, wherein the confidence map is an occlusion-based confidence map.

7. The apparatus of claim 1, wherein the one or more processors are configured to determine the confidence map based on a first-to-second disparity map between the first image and the second image and a second-to-first disparity map between the second image and the first image.

8. The apparatus of claim 7, wherein the one or more processors are configured to:
predict, using the machine-learning model, the first-to-second disparity map between the first image and the second image;
flip the first image to generate a flipped first image;
flip the second image to generate a flipped second image; and
predict, using the machine-learning model, the second-to-first disparity map based on the flipped second image and the flipped first image.

9. The apparatus of claim 8, wherein the confidence map is determined based on an the first-to-second disparity map and a flipped second-to-first disparity map.

10. The apparatus of claim 7, wherein:
a small difference between a first disparity of the first-to-second disparity map and an inverse of a corresponding disparity of the second-to-first disparity map relates to a high value in the confidence map; and
a large difference between a first disparity of the first-to-second disparity map and an inverse of a corresponding disparity of the second-to-first disparity map relates to a low value in the confidence map.

11. The apparatus of claim 1, wherein the error is determined based on the confidence map to increase error values for high-confidence pixels and to decrease error values for low-confidence pixels.

12. The apparatus of claim 1, wherein, to determine the confidence map, the one or more processors are configured to:
determine a learning-difficulty-balance confidence map based on a comparison of the predicted disparity map with the ground-truth disparity map; and
determine an occlusion-based confidence map based on the first image and the second image;
wherein the error is determined based on the learning-difficulty-balance confidence map and the occlusion-based confidence map.

13. The apparatus of claim 12, wherein:
the error is determined based on an inverse of the learning-difficulty-balance confidence map to increase error values for low-confidence pixels of the learning-difficulty-balance confidence map and to decrease error values for high-confidence pixels of the learning-difficulty-balance confidence map; and
the error is determined based on the occlusion-based confidence map to increase error values for high-confidence pixels of the occlusion-based confidence map and to decrease error values for low-confidence pixels of the occlusion-based confidence map.

14. The apparatus of claim 1, wherein the first image is captured by a first camera and wherein the second image is captured by a second camera.

15. The apparatus of claim 14, further comprising the first camera and the second camera.

16. The apparatus of claim 1, wherein the one or more processors are configured to adjust the at least one parameter on the apparatus in an online training process.

17. The apparatus of claim 1, wherein the one or more processors are configured to provide at least one image based on a disparity-map prediction from the machine-learning model to a display to be displayed.

18. A method for processing image data, the method comprising:
predicting, using a machine-learning model, a disparity map between a first image and a second image to generate a predicted disparity map, wherein the first image is captured from a first position and wherein the second image is captured from a second position;
determining a confidence map based on the predicted disparity map;
determining an error based on the confidence map and a comparison of the predicted disparity map and a ground-truth disparity map; and
adjusting at least one parameter of the machine-learning model based on the error.

19. The method of claim 18, wherein the confidence map is a learning-difficulty-balance confidence map.

20. The method of claim 18, further comprising determining the confidence map based on a comparison of the predicted disparity map with the ground-truth disparity map.
